(19) United States
(12) Patent Application Publication
(10) Pub. No.: US 2026/0171407 A1
(43) Pub. Date: Jun. 18, 2026

(54) CATHODE ACTIVE MATERIAL AND METHOD FOR PREPARING SAME

(71) Applicant: INDUSTRY-UNIVERSITY COOPERATION FOUNDATION HANYANG UNIVERSITY ERICA CAMPUS, Ansan-si (KR)

(72) Inventors: Jin Ho BANG, Ansan-si (KR); Doo Seok KWON, Ansan-si (KR)

(21) Appl. No.: 19/535,304

(22) Filed: Feb. 10, 2026

Related U.S. Application Data
(63) Continuation of application No. PCT/KR2024/011567, filed on Aug. 6, 2024.

(30) Foreign Application Priority Data
Aug. 10, 2023 (KR) 10-2023-0104890

(51) Int. Cl. H01M 4/525; C01G 53/50; C01G 53/84

(52) U.S. Cl. CPC H01M 4/525; C01G 53/50; C01G 53/84; C01P 2002/54; C01P 2002/74; C01P 2002/85; C01P 2004/03; C01P 2004/04; C01P 2004/50; C01P 2004/64; C01P 2006/40

(57) ABSTRACT

A method for manufacturing a cathode active material comprises: preparing a cathode active material precursor; setting the temperature in heat treatment equipment to a target firing temperature; and firing the cathode active material precursor, a lithium salt, and a dopant material at the target firing temperature using the heat treatment equipment to manufacture the cathode active material, wherein the target firing temperature is controlled according to the dopant material. The setting the temperature in the heat treatment equipment to a target firing temperature includes: obtaining the difference value between a set firing temperature of the heat treatment equipment and the actual firing temperature in the heat treatment equipment; constructing a DB on the basis of the difference value; and using the DB to set the set firing temperature of the heat treatment equipment so that the target firing temperature matches the actual firing temperature in the heat treatment equipment.

### CROSS-REFERENCE TO RELATED APPLICATION

This application is a bypass continuation of pending PCT International Application No. PCT/KR2024/011567, which was filed on Aug. 6, 2024, and which claims priority to and the benefit of Korean Patent Application No. 10-2023-0104890, which was filed in the Korean Intellectual Property Office on Aug. 10, 2023, the disclosure of which are incorporated herein by reference in its entirety.

### TECHNICAL FIELD

The present invention relates to a cathode active material and a method for manufacturing the same, and more specifically, to a cathode active material including a lithium metal, a nickel metal, a manganese metal, and a dopant, and a method for manufacturing the same.

### BACKGROUND ART

A cathode active material refers to an active material that exists in a cathode material of a secondary battery and electrochemically generates electrical energy.

The cathode active material present in the cathode material has lithium ions in an initial state, and serves to provide lithium ions to a cathode during a charging process of the secondary battery.

Accordingly, the cathode active material is used in various industries such as lithium metal batteries, lithium air batteries, lithium ion polymer batteries, etc.

As an application field increases, various cathode active materials are being studied. For example, Korean Patent Registration Publication No. 10-0815583 discloses a method for manufacturing a cathode active material for a lithium secondary battery, the method including: mixing a metal salt aqueous solution, which contains a first metal including nickel, cobalt and manganese, and optionally a second metal, a chelating agent, and a basic aqueous solution to prepare a co-precipitation compound; drying or heat-treating the co-precipitation compound to prepare an active material precursor; and mixing and firing the active material precursor and a lithium salt to prepare a lithium composite metal oxide, in which the lithium composite metal oxide has a layered structure.

### DISCLOSURE

### Technical Problem

One technical object of the present invention is to provide a method for manufacturing a cathode active material with improved reproducibility.

Another technical object of the present invention is to provide a method for manufacturing a cathode active material in which an initial capacity of a lithium secondary battery and a capacity retention rate thereof for a charge/discharge cycle are optimized.

Still another technical object of the present invention is to provide a method for manufacturing a cathode active material with a reduced manufacturing process cost.

Still another technical object of the present invention is to provide a method for manufacturing a cathode active material with a shortened manufacturing time.

Still another technical object of the present invention is to provide a method for manufacturing a cathode active material that is easy to mass-produce.

The technical problems to be solved by the present invention are not limited to the above-described problems.

### Technical Solution

In order to solve the above technical problems, the present invention may provide a method for manufacturing a cathode active material.

According to one embodiment, the method for manufacturing the cathode active material may include: preparing a cathode active material precursor; setting a temperature in heat treatment equipment to a target firing temperature; and firing the cathode active material precursor, a lithium salt, and a dopant material at the target firing temperature using the heat treatment equipment to manufacture a cathode active material, wherein the target firing temperature is controlled according to the dopant material. The step for setting the temperature in the heat treatment equipment to a target firing temperature may include: a step for obtaining the difference value between a set firing temperature of the heat treatment equipment and the actual firing temperature in the heat treatment equipment; a step for constructing a DB on the basis of the difference value; and a step for using the DB to set the set firing temperature of the heat treatment equipment so that the target firing temperature matches the actual firing temperature in the heat treatment equipment.

According to one embodiment, the setting of the target firing temperature of the heat treatment equipment may include setting the set firing temperature of the heat treatment equipment lower than the target firing temperature of the heat treatment equipment.

According to one embodiment, an initial capacity and a capacity retention rate of a lithium secondary battery may be controlled according to the target firing temperature.

According to one embodiment, the dopant material may include at least one of Nb, Ti, Zr, Hf, Ta, W, or Mo.

According to one embodiment, the target firing temperature may be controlled to be 700° C. or more and 900° C. or less.

According to one embodiment, when the dopant material is Ti, the target firing temperature may be controlled to be more than 725° C. and less than 750° C., or the dopant material may be Hf and the target firing temperature may be controlled to be more than 725° C. and less than 775° C., or the dopant material may be Nb and the target firing temperature may be controlled to be more than 725° C. and less than 775° C., or the dopant material may be Ta and the target firing temperature may be controlled to be more than 750° C. and less than 800° C., or the dopant material may be W and the target firing temperature may be controlled to be more than 800° C. and less than 900° C., or the dopant material may be Mo and the target firing temperature may be controlled to be more than 725° C. and less than 750° C., or the dopant material may be Zr and the target firing temperature may be controlled to be more than 700° C. and less than 750° C.

According to one embodiment, stress may be applied to a plane (104) of the preliminary cathode active material in which the cathode active material precursor, the lithium salt, and the dopant material are mixed, and thus the particles of the cathode active material may grow to a plane (003) rather than the plane (104) in the process of heat-treating at the target firing temperature.

According to one embodiment, the preliminary cathode active material may not include cobalt.

According to one embodiment, I₍₀₀₃₎/I₍₁₀₄₎, which is a ratio of a peak value I₍₀₀₃₎ corresponding to the plane (003) and a peak value I₍₁₀₄₎ corresponding to the plane (104), may be controlled to be more than 1.0 and less than 1.1.

According to one embodiment, the preparing of the cathode active material precursor may include manufacturing a transition metal hydroxide by a co-precipitation method using a transition metal precursor.

According to one embodiment, the transition metal precursor may not include cobalt, and the transition metal precursor may include a nickel precursor and a manganese precursor.

According to one embodiment, a ratio of the cathode active material precursor, the lithium salt, and the dopant material may be controlled to be 1.03:1.00:0.01.

According to one embodiment, the nickel precursor may include NiSO₄6H₂O, the manganese precursor may include MnSO₄5H₂O, and the lithium salt may include LiOHH₂O.

In order to solve the above technical problems, the present invention may provide a cathode active material manufactured by the method for manufacturing the cathode active material as described above.

According to one embodiment, the cathode active material may include a secondary particle in which a plurality of primary particles are aggregated, in which among a surface and an inside of the cathode active material, more primary particles having a rod shape are included on the surface than in the inside, in which the cathode active material includes a lithium metal, a nickel metal at a smaller ratio than that of the lithium metal, a manganese metal at a smaller ratio than that of the nickel metal, and a dopant at a smaller ratio than that of the manganese metal, in which the dopant ratio is higher on the surface than in the inside, a grain size of the cathode active material is 40 nm or more and 60 nm or less, and when the cathode active material is subjected to XRD analysis, I₍₀₀₃₎/I₍₁₀₄₎, which is a ratio between a peak value I₍₀₀₃₎ corresponding to a plane (003) and a peak value I₍₁₀₄₎ corresponding to a plane (104), is more than 1.0 and less than 1.1.

According to one embodiment, the cathode active material may not include cobalt.

According to one embodiment, when the cathode active material is subjected to XRD analysis, c/3a, which is a ratio of a crystal lattice of the cathode active material to a c-axis and an a-axis, may exceed 1.6459.

According to one embodiment, the cathode active material may include a transition metal layer including the nickel metal and the manganese metal and a lithium layer including the lithium metal, which are alternately and repeatedly stacked, and a superlattice in which +2 valent ions of the nickel metal are mixed in the lithium layer.

According to one embodiment, the dopant may include Ti, a ratio at which the +2 valent ions of the nickel metal are mixed in the lithium layer increases as the temperature constant (θp) of the cathode active material increases, and the temperature constant (θp) of the cathode active material is more than 24.2K and less than 28.1K.

### Advantageous Effects

A method for manufacturing a cathode active material according to the present invention can include: preparing a cathode active material precursor; setting a temperature in heat treatment equipment to a target firing temperature; and firing the cathode active material precursor, a lithium salt, and a dopant material at the target firing temperature using the heat treatment equipment to manufacture the cathode active material.

In the setting of the temperature in the heat treatment equipment to the target firing temperature, a set temperature displayed on a display disposed in the heat treatment equipment can be set lower than the target firing temperature. Accordingly, a preliminary cathode active material, in which the cathode active material precursor, the lithium salt, and the dopant material are physically mixed, can be fired at the target firing temperature. Accordingly, in the firing process of the preliminary cathode active material, a change in properties of the cathode active material caused by a deviation in the firing temperature can be minimized. In other words, reproducibility for the manufacturing of the cathode active material can be improved. Accordingly, the cathode active material having the same quality can be provided.

In addition, in the firing of the preliminary cathode active material at the target firing temperature using the heat treatment equipment to manufacture the cathode active material, the target firing temperature can be controlled to be 700° C. or more and 900° C. or less. Specifically, the target firing temperature can be differently controlled according to the dopant material in the preliminary cathode active material. When the dopant material is Ti, the target firing temperature of the preliminary cathode active material can be controlled to be more than 725° C. and 750° C. Accordingly, the cathode active material with optimized initial capacity and capacity retention rate of a lithium secondary battery can be provided.

The cathode active material manufactured by the above-described method for manufacturing the cathode active material can include a secondary particle in which a plurality of primary particles are aggregated. The plurality of primary particles can have a rod shape. The plurality of primary particles having the rod shape can be present on the surface of the cathode active material more than in the inside of the cathode active material.

In addition, the cathode active material can include a lithium metal, a nickel metal at a smaller ratio than that of the lithium metal, a manganese metal at a smaller than that of the nickel metal, and a dopant at a smaller ratio than that of the manganese metal. The dopant can be present at a higher ratio on the surface of the cathode active material than in the inside of the cathode active material.

In addition, the cathode active material can include a transition metal layer including the nickel metal and the manganese metal and a lithium layer including the lithium metal, which are alternately and repeatedly stacked. The cathode active material can include a superlattice, since +2 valent ions of the nickel metal are mixed in the lithium layer, and the dopant is doped in the transition metal layer.

Accordingly, when the cathode active material is applied to the lithium secondary battery, an initial capacity of the lithium secondary battery and a capacity retention rate thereof for a charge/discharge cycle can be optimized.

### DESCRIPTION OF DRAWINGS

FIG. 1 is a flowchart for describing a method for manufacturing a cathode active material according to an embodiment of the present invention.

FIG. 2 is a view for describing a nickel precursor, a manganese precursor, a lithium salt, and a dopant material according to an embodiment of the present invention.

FIG. 3 is a view for describing a method for manufacturing a transition metal precursor by mixing a nickel precursor and a manganese precursor according to an embodiment of the present invention.

FIG. 4 is a view for describing a method for manufacturing a cathode active material by subjecting a transition metal precursor to a co-precipitation reaction according to an embodiment of the present invention.

FIG. 5 is a view for describing a method for manufacturing a preliminary cathode active material by mixing a cathode active material, a lithium salt, and a dopant according to an embodiment of the present invention.

FIG. 6 is a view for describing a method for manufacturing a cathode active material by firing a preliminary cathode active material according to an embodiment of the present invention.

FIG. 7 is a view for describing a structure of a cathode active material according to an embodiment of the present invention.

FIG. 8 is a graph for comparing a set firing temperature of heat treatment equipment and an actual temperature in the heat treatment equipment according to an experimental example of the present invention.

FIGS. 9 to 11 are graphs for comparing an initial capacity of a lithium ion battery with cathode active materials applied thereto, and a capacity retention rate thereof for a charge/discharge cycle according to experimental examples of the present invention.

FIG. 12 is a table for comparing results of XRD analysis on cathode active materials according to experimental examples of the present invention.

FIGS. 13 and 14 are graphs for comparing a correlation between a performance of a lithium ion battery with cathode active materials applied thereto, and a grain size of the cathode active materials according to experimental examples of the present invention.

FIG. 15 is a graph for comparing the W-H Plot of cathode active materials according to comparative examples of the present invention.

FIGS. 16 to 22 are graphs for comparing the W-H Plot of cathode active materials according to experimental examples of the present invention.

FIG. 23 is an SEM picture of a cathode active material according to comparative example 1-1 of the present invention.

FIGS. 24 to 30 are SEM pictures of cathode active materials and graphs for comparing results of EDS mapping analysis according to experimental examples of the present invention.

FIGS. 31 and 32 are graphs for comparing the crystal stability of a cathode active materials according to comparative and experimental examples of the present invention.

FIG. 33 is a FIB-TEM picture of a cathode active material according to experimental example 2-2 of the present invention.

FIG. 34 is an FIB-TEM picture of a cathode active material according to experimental example 2-5 of the present invention.

FIGS. 35 to 38 are graphs for comparing crystal structures of cathode active materials according to experimental examples 2-2 and 2-5 before/after charge/discharge cycles of a lithium ion battery with cathode active materials applied thereto according to experimental examples 2-2 and 2-5 of the present invention.

FIG. 39 is an SEM picture of cathode active materials according to experimental examples 2-2 and 2-5 after performing charge/discharge cycles of lithium ion batteries with cathode active materials applied thereto according to experimental examples 2-2 and 2-5 of the present invention.

FIG. 40 is a graph for comparing a temperature constant (θp) and I₍₀₀₃₎/I₍₁₀₄₎ for cathode active materials according to experimental examples 2-1, 2-2 and 2-5 of the present invention.

FIG. 41 is a table for comparing results of ICP analysis on cathode active materials according to experimental examples of the present invention.

### MODE FOR INVENTION

Hereinafter, preferred embodiments of the present invention will be described in detail with reference to the accompanying drawings. However, the technical spirit of the present invention is not limited to the embodiments described herein and may be implemented in other forms. Rather, the embodiments introduced herein are provided so that the disclosed contents may be thorough and complete and the spirit of the present invention may be sufficiently conveyed to those skilled in the art.

In this specification, when a component is referred to as being on another component, it means that it may be formed directly on the other component or a third component may be interposed therebetween. In addition, in the drawings, the thicknesses of films and regions are exaggerated for effective description of the technical contents.

Furthermore, in various embodiments of the present specification, terms such as first, second, third, etc., are used to describe various components, but these components should not be limited by these terms. These terms have only been used to distinguish one component from another component. Accordingly, a component mentioned as a first component in one embodiment may be mentioned as a second component in another embodiment. Each embodiment described and exemplified herein includes a complementary embodiment thereof. In addition, in the present specification, “and/or” is used as a meaning including at least one of the components listed before and after.

In the specification, a singular expression includes a plural expression unless the context clearly indicates otherwise. In addition, terms such as “include,” “have” or the like are intended to designate the presence of features, numbers, steps, components, or combinations thereof described in the specification, and should not be understood to preclude the possibility of the presence or addition of one or more other features, numbers, steps, components, or combinations thereof. In addition, in the present specification, “connection” is used as a meaning including both indirectly connecting a plurality of components and directly connecting the plurality of components.

Furthermore, in the following description of the present invention, when it is determined that a detailed description of a related known function or configuration may unnecessarily obscure the subject matter of the present invention, the detailed description thereof will be omitted.

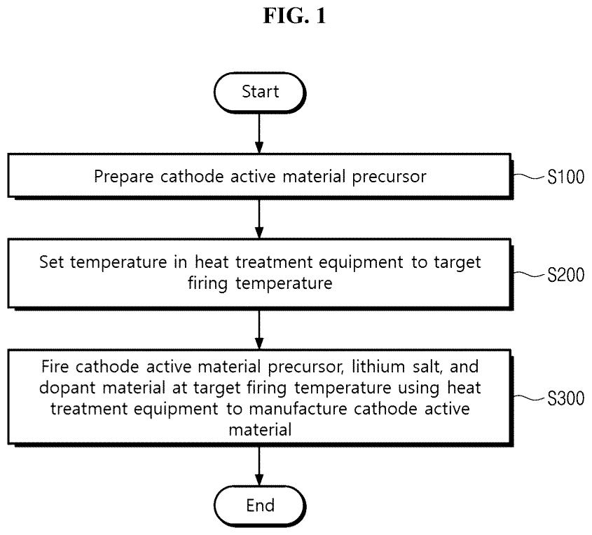

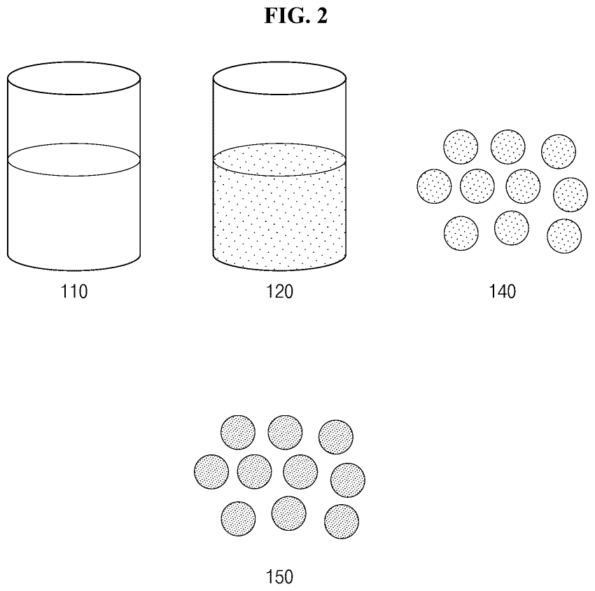

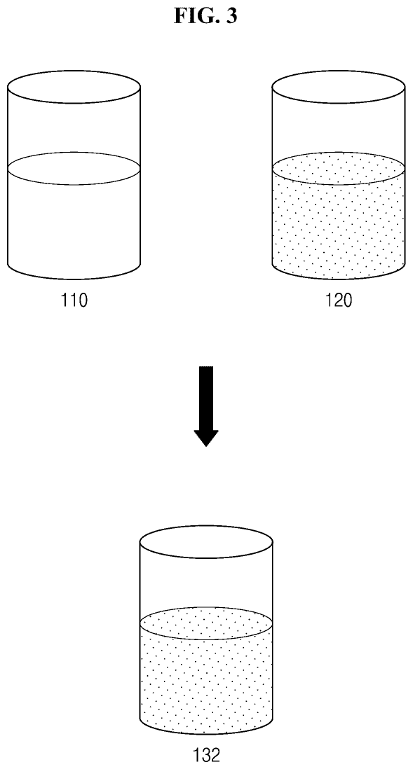

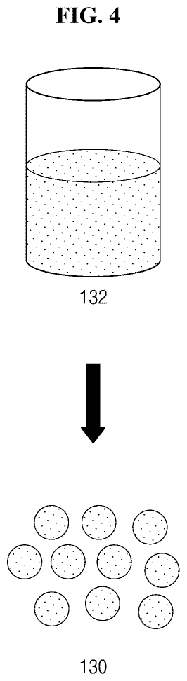

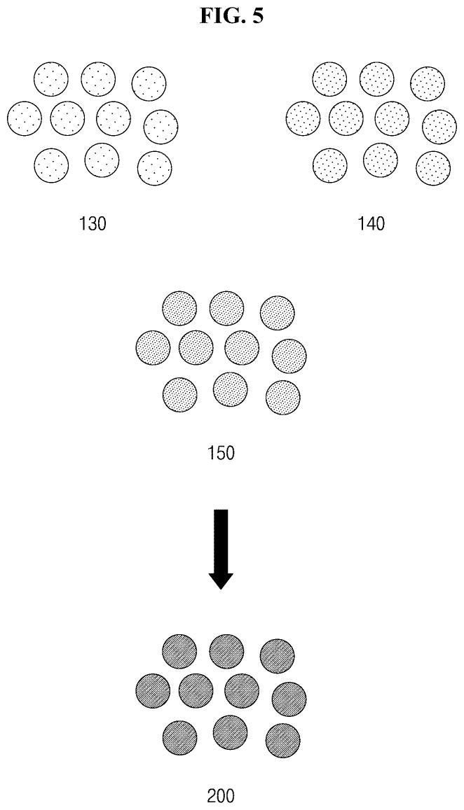

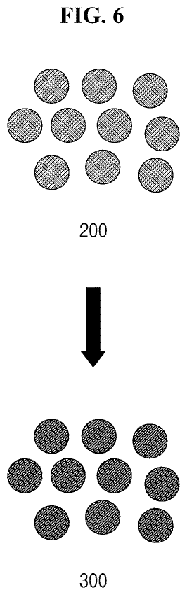

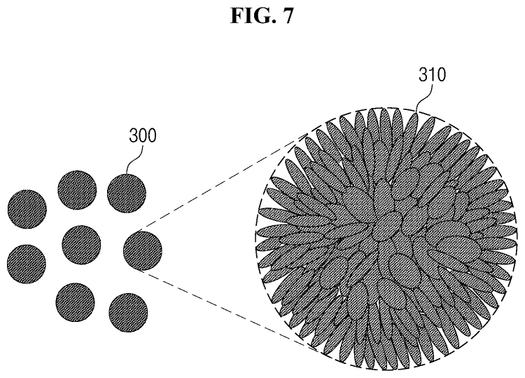

FIG. 1 is a flowchart for describing a method for manufacturing a cathode active material according to an embodiment of the present invention, FIG. 2 is a view for describing a nickel precursor, a manganese precursor, a lithium salt, and a dopant material according to an embodiment of the present invention, FIG. 3 is a view for describing a method for manufacturing a transition metal precursor by mixing a nickel precursor and a manganese precursor according to an embodiment of the present invention, FIG. 4 is a view for describing a method for manufacturing a cathode active material by subjecting a transition metal precursor to a co-precipitation reaction according to an embodiment of the present invention, FIG. 5 is a view for describing a method for manufacturing a preliminary cathode active material by mixing a cathode active material, a lithium salt, and a dopant according to an embodiment of the present invention, FIG. 6 is a view for describing a method for manufacturing a cathode active material by firing a preliminary cathode active material according to an embodiment of the present invention, and FIG. 7 is a view for describing a structure of a cathode active material according to an embodiment of the present invention.

Referring to FIGS. 1 and 2 to 4, a cathode active material precursor 130 may be prepared (S100).

The preparing of the cathode active material precursor 130 may include manufacturing a transition metal hydroxide by co-precipitating a transition metal precursor 132.

The transition metal precursor 132 may not include cobalt (Co), and may include a nickel precursor 110 and a manganese precursor 120 as shown in FIG. 2. For example, the nickel precursor 100 may be NiSO₄6H₂O. For example, the manganese precursor 120 may be MnSO₄5H₂O. For example, the transition metal hydroxide may be NiMn(OH)₂.

According to one embodiment, the transition metal precursor 132 may be manufactured by mixing the nickel precursor 110 and the manganese precursor 120 at a lower ratio than that of the nickel precursor 100 as shown in FIG. 3. As a specific example, a ratio between the nickel precursor 110 and the nickel precursor 100 may be 95:5.

In addition, the cathode active material precursor 130 may be manufactured by a method of co-precipitating the transition metal precursor 132 as shown in FIG. 4. As a specific example, a co-precipitation reaction may be performed in a nitrogen atmosphere. As a specific example, a co-precipitation reaction temperature may be 45.5° C. As a specific example, a pH condition of the co-precipitation reaction may be pH 11. As a specific example, a co-precipitation stirring speed may be 900 rpm. As a specific example, a co-precipitation reaction time may be 24 hours. For example, the cathode active material precursor 130 may be the transition metal hydroxide. As a specific example, the cathode active material precursor 130 may be nickel manganese hydroxide (Ni_{0.95}Mn_{0.05}(OH)₂). Accordingly, a process of manufacturing the cathode active material precursor 130 may be simplified, and a manufacturing time of the cathode active material 300 to be described later may be shortened. Thus, a manufacturing process cost of the cathode active material 300 to be described later may be reduced, and thus mass production of the cathode active material 300 to be described later may be facilitated.

Referring to FIG. 1, a temperature in heat treatment equipment may be set to be a target firing temperature (S200).

The setting of the temperature in the heat treatment equipment to the target firing temperature may include: obtaining a difference value between a set firing temperature of the heat treatment equipment and an actual firing temperature in the heat treatment equipment; constructing a DB on the basis of the difference value; and using the DB to set the set firing temperature of the heat treatment equipment so that the target firing temperature matches the actual firing temperature in the heat treatment equipment.

In the present application, the set firing temperature of the heat treatment equipment may mean a temperature displayed on a display screen disposed on the heat treatment equipment, and mean a temperature that a user of the heat treatment equipment may operate through the display screen.

In addition, the target firing temperature may mean a temperature at which a preliminary cathode active material 200 to be described later is fired. The target firing temperature may be controlled to be 700° C. or more and 900° C. or less. Specifically, the target firing temperature may be differently controlled according to a dopant material 150 in the preliminary cathode active material 200 to be described later.

In addition, the actual firing temperature in the heat treatment equipment may mean a temperature measured at a reactor in the heat treatment apparatus according to the set firing temperature of the heat treatment equipment. Accordingly, the difference value between the set firing temperature of the heat treatment equipment and the actual firing temperature in the heat treatment equipment may mean a difference between the set firing temperature of the heat treatment equipment and the actual temperature measured at the reactor in the heat treatment equipment.

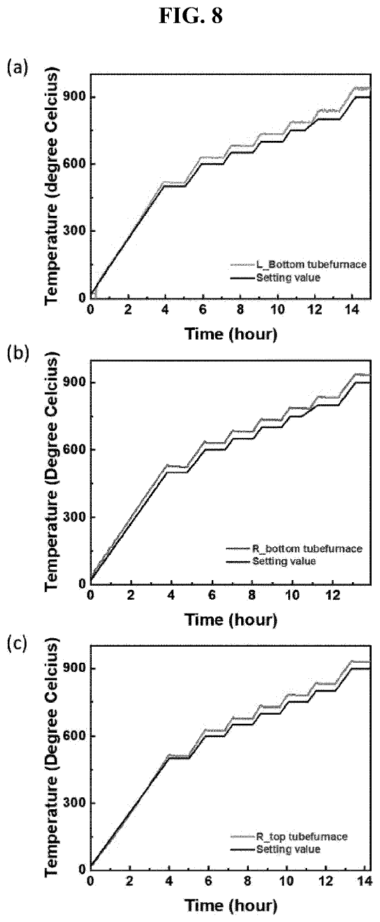

As will be described later in FIG. 8, the actual temperature measured at the reactor in the heat treatment equipment may be higher than the set firing temperature of the heat treatment equipment. Accordingly, in the setting of the target firing temperature of the heat treatment equipment, the set firing temperature of the heat treatment equipment may be set lower than the target firing temperature of the heat treatment equipment. Accordingly, the preliminary cathode active material 200 to be described later may be fired at the target firing temperature. Thus, in the firing process of the preliminary cathode active material 200, a change in properties of the cathode active material 300 to be described later, which is caused by a deviation in the firing temperature, may be minimized. In other words, reproducibility for the manufacturing of the cathode active material 300 to be described below may be improved. Accordingly, the cathode active material 300 having the same quality to be described later may be provided.

Referring to FIGS. 1, 5 and 6, the cathode active material precursor 130, the lithium salt 140, and the dopant material 150 may be fired at the target firing temperature using the heat treatment equipment to manufacture the cathode active material 300 (S300).

The cathode active material precursor 130, the lithium salt 140, and the dopant material 150 may be physically mixed to manufacture the above-described preliminary cathode active material 200, as shown in FIG. 5. As a specific example, the cathode active material precursor 130 may be nickel manganese hydroxide (Ni_{0.95}Mn_{0.05}(OH)₂). As a specific example, the lithium salt 140 may be LiOHH₂O. For example, the dopant material 150 may be at least one of Nb, Ti, Zr, Hf, Ta, W, or Mo. As a specific example, a ratio of mixing the cathode active material 130, the lithium salt 140, and the dopant material 150 may be 1.03:1. 00:0.01.

In addition, the preliminary cathode active material 200 shown in FIG. 6 may be provided to the reactor in the heat treatment equipment, and the preliminary cathode active material 200 may be fired at the target firing temperature while supplying oxygen to the reactor, thereby manufacturing the cathode active material 300. For example, a flow rate of oxygen supplied to the reactor may be controlled to be 0.6 L/min.

In addition, before the preliminary cathode active material 200 is fired at the target firing temperature, the preliminary cathode active material 200 may be heat-treated in advance at a temperature lower than the target firing temperature. In this case, for example, the heat treatment temperature of the preliminary cathode active material 200 may be 500° C.

As described above, the target firing temperature may be controlled to be 700° C. or more and 900° C. or less. Specifically, the target firing temperature may be differently controlled according to the dopant material 150 in the preliminary cathode active material 200.

As a specific example, when the dopant material 150 is Ti, the target firing temperature may be controlled to be more than 725° C. and less than 750° C. Accordingly, when the manufactured cathode active material 300 is applied to a lithium secondary battery, an initial capacity and capacity retention rate of the lithium secondary battery may be optimized. On the contrary, when the cathode active material 300 manufactured by firing the preliminary cathode active material 200 at 725° C. or less or 750° C. or more is applied to the lithium secondary battery, the initial capacity and/or capacity retention rate of the lithium secondary battery may be reduced.

Thus, in the method for manufacturing the cathode active material 300 according to an embodiment of the present application, when the dopant material 150 is Ti, the target firing temperature of the preliminary cathode active material 200 may be controlled to be more than 725° C. and less than 750° C. Accordingly, the cathode active material 300 with optimized initial capacity and capacity retention rate of the lithium secondary battery may be provided.

Consequently, the method for manufacturing the cathode active material 300 according to an embodiment of the present application may include preparing the cathode active material precursor 130, setting the temperature in the heat treatment equipment to the target firing temperature, and firing the cathode active material precursor 130, the lithium salt 140, and the dopant material 150 at the target firing temperature using the heat treatment equipment to manufacture the cathode active material 300.

In the setting of the temperature in the heat treatment equipment to the target firing temperature, a set temperature displayed on the display disposed in the heat treatment equipment may be set lower than the target firing temperature. Accordingly, the preliminary cathode active material 200, in which the cathode active material precursor 130, the lithium salt 140, and the dopant material 150 are physically mixed, may be fired at the target firing temperature. Accordingly, in the firing process of the preliminary cathode active material 200, a change in properties of the cathode active material 300 caused by a deviation in the firing temperature may be minimized. In other words, reproducibility for the manufacturing of the cathode active material 300 may be improved. Accordingly, the cathode active material 300 having the same quality may be provided.

In addition, in the firing of the preliminary cathode active material 200 at the target firing temperature using the heat treatment equipment to manufacture the cathode active material 300, the target firing temperature may be controlled to be 700° C. or more and 900° C. or less. Specifically, the target firing temperature may be differently controlled according to the dopant material 150 in the preliminary cathode active material 200. When the dopant material is Ti, the target firing temperature of the preliminary cathode active material 200 may be controlled to be more than 725° C. and 750° C. Accordingly, the cathode active material 300 with optimized initial capacity and capacity retention rate of the lithium secondary battery may be provided.

Referring to FIG. 7, a structure of the cathode active material 300 will be described.

As shown in FIG. 7, the cathode active material 300 may include a secondary particle in which a plurality of primary particles 310 are aggregated. The plurality of primary particles 310 may have a rod shape. The plurality of primary particles 310 having the rod shape may be present on the surface of the cathode active material 300 more than in the inside of the cathode active material 300.

In addition, the cathode active material 300 may include a lithium metal, a nickel metal at a smaller ratio than that of the lithium metal, a manganese metal at a smaller than that of the nickel metal, and a dopant at a smaller ratio than that of the manganese metal. The dopant may be present at a higher ratio on the surface of the cathode active material 300 than in the inside of the electrode active material 300. For example, the dopant material may be at least one of Nb, Ti, Zr, Hf, Ta, W, or Mo. As a specific example, the dopant may be Ti. In addition, the cathode active material 300 may include a transition metal layer including the nickel metal and the manganese metal and a lithium layer including the lithium metal, which are alternately and repeatedly stacked. The cathode active material 300 may include a superlattice, since +2 valent ions of the nickel metal are mixed in the lithium layer, and the dopant is doped in the transition metal layer.

Accordingly, when the cathode active material 300 is applied to the lithium secondary battery, an initial capacity of the lithium secondary battery and a capacity retention rate thereof for a charge/discharge cycle may be optimized.

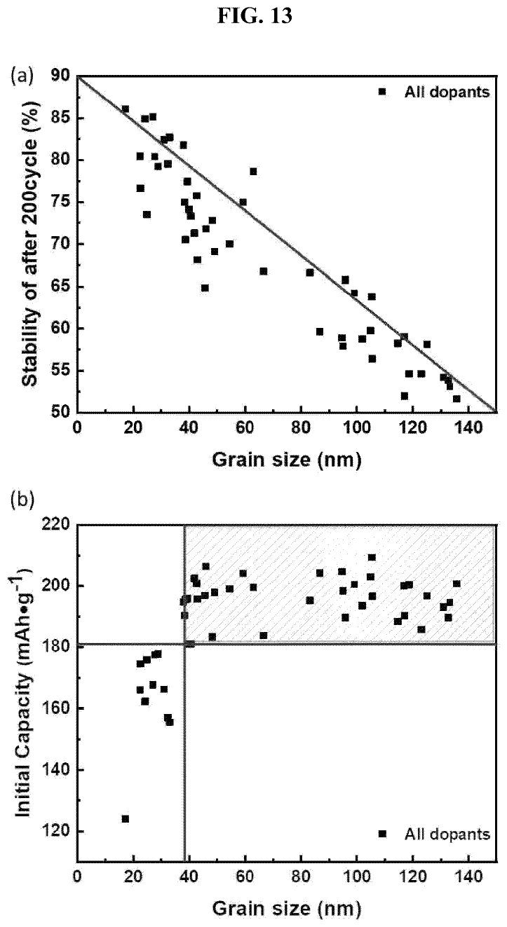

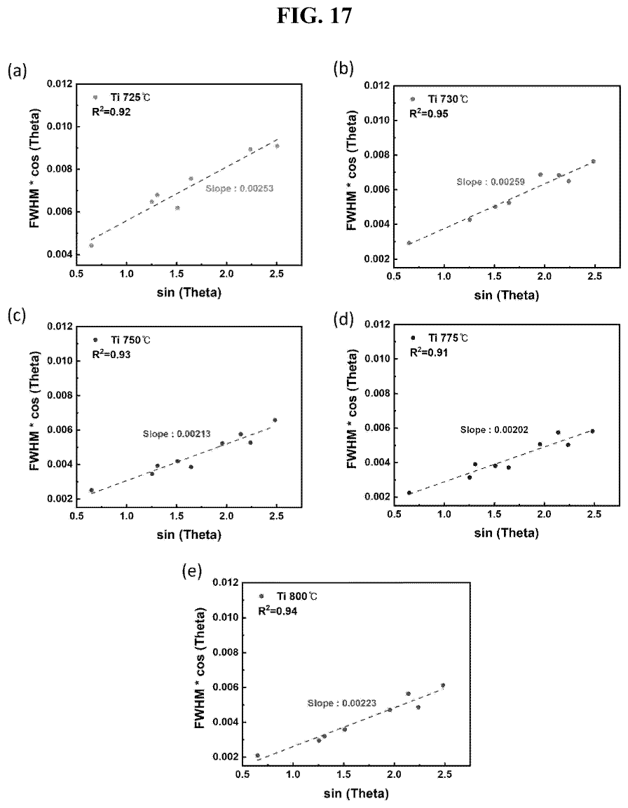

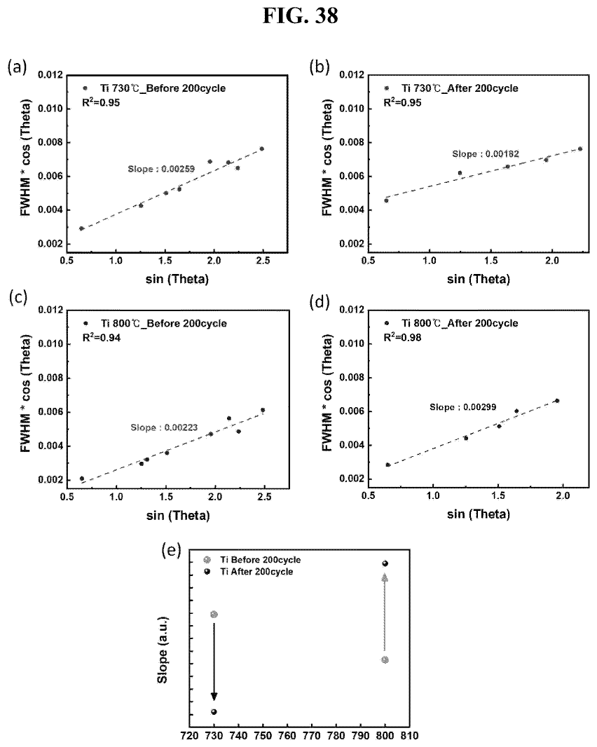

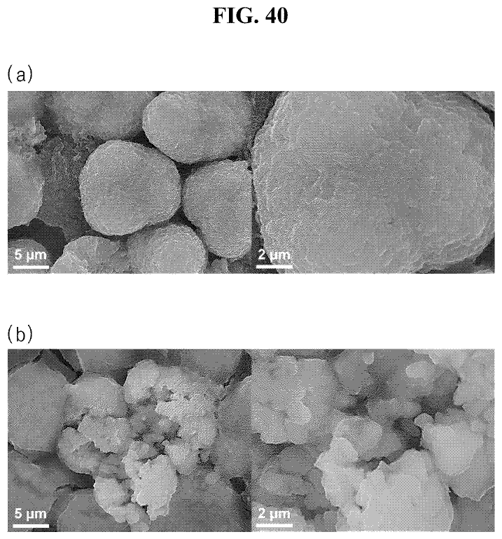

In addition, when the cathode active material 300 is subjected to XRD analysis, c/3a, which is a ratio of a crystal lattice of the cathode active material to a c-axis and an a-axis, may exceed 1.6459. Accordingly, crystal stability of the cathode active material 300 may be improved. Thus, durability of the cathode active material 300 may be increased, and thus a capacity retention rate of the lithium secondary battery with the cathode active material 300 thereto for a charge/discharge cycle may be improved. In addition, when the cathode active material 300 is subjected to XRD, a grain size of the cathode active material 300 may be 40 nm to 60 nm as described below with reference to FIG. 13. Accordingly, an initial capacity of the lithium secondary battery with the cathode active material 300 applied thereto, and a capacity retention rate thereof for a charge/discharge cycle may be optimized. In addition, when the cathode active material 300 is subjected to XRD analysis, a ratio (I₍₀₀₃₎/I₍₁₀₄₎) between a peak value (I₍₀₀₃₎) corresponding to a plane (003) and a peak value (I₍₁₀₄₎) corresponding to a plane (104) may be more than 1.0 and less than 1.1. Accordingly, a ratio at which +2 valent ions of the nickel metal are mixed in the lithium layer of the cathode active material 300 may be optimized, and thus an initial capacity of the lithium secondary battery with the cathode active material 300 applied thereto, and a capacity retention rate thereof for a charge/discharge cycle may be optimized. In addition, as will be described later with reference to FIG. 17, a slope of the cathode active material 300 with respect to the Williamson-Hall Plot (W-H Plot) may exceed 0.00253. Furthermore, as will be described later with reference to FIG. 38, the cathode active material 300 may have a feature in which the slope of the cathode active material 300 with respect to W-H Plot is reduced after performing a charge/discharge cycle of the lithium secondary battery with the cathode active material 300 applied thereto. Moreover, as will be described later with reference to FIG. 40, a temperature constant (θp) of the cathode active material 300 may be more than 24.2K. and less than 28.1K. Accordingly, a ratio at which +2 valent ions of the nickel metal are mixed in the lithium layer of the cathode active material 300 may be optimized, and thus an initial capacity of the lithium secondary battery with the cathode active material 300 applied thereto, and a capacity retention rate thereof for a charge/discharge cycle may be optimized.

Consequently, the cathode active material 300 according to an embodiment of the present application may include the secondary particle in which the plurality of primary particles 310 are aggregated. The plurality of primary particles 310 may have a rod shape. The plurality of primary particles 310 having the rod shape may be present on the surface of the cathode active material 300 more than in the inside of the cathode active material 300.

In addition, the cathode active material 300 may include the lithium metal, the nickel metal at a smaller ratio than that of the lithium metal, the manganese metal at a smaller than that of the nickel metal, and the dopant at a smaller ratio than that of the manganese metal. The dopant may be present at a higher ratio on the surface of the cathode active material 300 than in the inside of the electrode active material 300.

In addition, the cathode active material 300 may include the transition metal layer including the nickel metal and the manganese metal and the lithium layer including the lithium metal, which are alternately and repeatedly stacked. The cathode active material 300 may include the superlattice, since +2 valent ions of the nickel metal are mixed in the lithium layer, and the dopant is doped in the transition metal layer.

Accordingly, when the cathode active material 300 is applied to the lithium secondary battery, an initial capacity of the lithium secondary battery and a capacity retention rate thereof for a charge/discharge cycle may be optimized.

Hereinafter, specific experimental examples and property evaluation results of the cathode active material according to an embodiment of the present invention will be described.

### Cathode Active Material Precursor According to Experimental Example

NiSO₄6H₂O was prepared as a nickel precursor, and MnSO₄5H₂O was prepared as a manganese precursor.

The nickel precursor and the manganese precursor were mixed at a ratio of 95:5 to manufacture a transition metal sulfate precursor (2M), which is a transition metal precursor. In addition, ammonia (3M) and sodium hydroxide (5M) were provided to the transition metal precursor, and subjected to a co-precipitation reaction under a co-precipitation condition (nitrogen atmosphere, 45.5° C. pH 11, stirring speed of 900 rpm, reaction time of 24 hours) to manufacture nickel manganese hydroxide (Ni_{0.95}Mn_{0.05}(OH)₂), which is a cathode active material precursor.

### Cathode Active Material According to Experimental Example 1-1

A cathode active material precursor (Ni_{0.95}Mn_{0.05}(OH)₂) according to an experimental example was prepared as a cathode active material precursor, LiOHH₂O was prepared as a lithium salt, and Nb was prepared as a dopant material.

The cathode active material precursor, the lithium salt, and the dopant material were provided to a mortar at a ratio of 1.03:1.00:0.01, primarily mixed in a mortar for 10 minutes, and secondarily mixed in Thinky Mixer for six minutes to manufacture a preliminary cathode active material.

The preliminary cathode active material was provided to a reactor in heat treatment equipment, and while oxygen was supplied to the reactor at 0.6 L/min, a temperature of the reactor was raised to 500° C. at 2° C./min, and subjected to heat treatment for five hours. After that, a set firing temperature of the heat treatment equipment was set so that the temperature of the reactor became 725° C., which is a target firing temperature, the temperature of the reactor was raised from 500° C. to 725° C. at 2° C./min, and then the reactor was fired at 725° C. for 10 hours to manufacture a cathode active material.

### Cathode Active Material According to Experimental Example 1-2

A cathode active material was manufactured in the same manner as in experimental example 1-1, except that a set firing temperature of heat treatment equipment was set so that a temperature of a reactor in the heat treatment equipment became 750° C., which is a target firing temperature.

### Cathode Active Material According to Experimental Example 1-3

A cathode active material was manufactured in the same manner as in experimental example 1-1, except that a set firing temperature of heat treatment equipment was set so that a temperature of a reactor in the heat treatment equipment became 775° C., which is a target firing temperature.

### Cathode Active Material According to Experimental Example 1-4

A cathode active material was manufactured in the same manner as in experimental example 1-1, except that a set firing temperature of heat treatment equipment was set so that a temperature of a reactor in the heat treatment equipment became 800° C., which is a target firing temperature.

### Cathode Active Material According to Experimental Example 2-1

A cathode active material was manufactured in the same manner as in experimental example 1-1, except that Ti was prepared as a dopant material.

### Cathode Active Material According to Experimental Example 2-2

A cathode active material was manufactured in the same manner as in experimental example 2-1, except that a set firing temperature of heat treatment equipment was set so that a temperature of a reactor in the heat treatment equipment became 730° C., which is a target firing temperature.

### Cathode Active Material According to Experimental Example 2-3

A cathode active material was manufactured in the same manner as in experimental example 2-1, except that a set firing temperature of heat treatment equipment was set so that a temperature of a reactor in the heat treatment equipment became 750° C., which is a target firing temperature.

### Cathode Active Material According to Experimental Example 2-4

A cathode active material was manufactured in the same manner as in experimental example 2-1, except that a set firing temperature of heat treatment equipment was set so that a temperature of a reactor in the heat treatment equipment became 775° C., which is a target firing temperature.

### Cathode Active Material According to Experimental Example 2-5

A cathode active material was manufactured in the same manner as in experimental example 2-1, except that a set firing temperature of heat treatment equipment was set so that a temperature of a reactor in the heat treatment equipment became 800° C., which is a target firing temperature.

### Cathode Active Material According to Experimental Example 3-1

A cathode active material was manufactured in the same manner as in experimental example 1-1, except that Zr was prepared as a dopant material and a set firing temperature of heat treatment equipment was set so that a temperature of a reactor in the heat treatment equipment became 700° C., which is a target firing temperature.

### Cathode Active Material According to Experimental Example 3-2

A cathode active material was manufactured in the same manner as in experimental example 3-1, except that a set firing temperature of heat treatment equipment was set so that a temperature of a reactor in the heat treatment equipment became 720° C., which is a target firing temperature.

### Cathode Active Material According to Experimental Example 3-3

A cathode active material was manufactured in the same manner as in experimental example 3-1, except that a set firing temperature of heat treatment equipment was set so that a temperature of a reactor in the heat treatment equipment became 750° C., which is a target firing temperature.

### Cathode Active Material According to Experimental Example 3-4

A cathode active material was manufactured in the same manner as in experimental example 3-1, except that a set firing temperature of heat treatment equipment was set so that a temperature of a reactor in the heat treatment equipment became 775° C., which is a target firing temperature.

### Cathode Active Material According to Experimental Example 3-5

A cathode active material was manufactured in the same manner as in experimental example 3-1, except that a set firing temperature of heat treatment equipment was set so that a temperature of a reactor in the heat treatment equipment became 800° C., which is a target firing temperature.

### Cathode Active Material According to Experimental Example 4-1

A cathode active material was manufactured in the same manner as in experimental example 1-1, except that Hf was prepared as a dopant material.

### Cathode Active Material According to Experimental Example 4-2

A cathode active material was manufactured in the same manner as in experimental example 4-1, except that a set firing temperature of heat treatment equipment was set so that a temperature of a reactor in the heat treatment equipment became 750° C., which is a target firing temperature.

### Cathode Active Material According to Experimental Example 4-3

A cathode active material was manufactured in the same manner as in experimental example 4-1, except that a set firing temperature of heat treatment equipment was set so that a temperature of a reactor in the heat treatment equipment became 775° C., which is a target firing temperature.

### Cathode Active Material According to Experimental Example 4-4

A cathode active material was manufactured in the same manner as in experimental example 4-1, except that a set firing temperature of heat treatment equipment was set so that a temperature of a reactor in the heat treatment equipment became 800° C., which is a target firing temperature.

### Cathode Active Material According to Experimental Example 5-1

A cathode active material was manufactured in the same manner as in experimental example 1-1, except that Ta was prepared as a dopant material.

### Cathode Active Material According to Experimental Example 5-2

A cathode active material was manufactured in the same manner as in experimental example 5-1, except that a set firing temperature of heat treatment equipment was set so that a temperature of a reactor in the heat treatment equipment became 750° C., which is a target firing temperature.

### Cathode Active Material According to Experimental Example 5-3

A cathode active material was manufactured in the same manner as in experimental example 5-1, except that a set firing temperature of heat treatment equipment was set so that a temperature of a reactor in the heat treatment equipment became 775° C., which is a target firing temperature.

### Cathode Active Material According to Experimental Example 5-4

A cathode active material was manufactured in the same manner as in experimental example 5-1, except that a set firing temperature of heat treatment equipment was set so that a temperature of a reactor in the heat treatment equipment became 800° C., which is a target firing temperature.

### Cathode Active Material According to Experimental Example 5-5

A cathode active material was manufactured in the same manner as in experimental example 5-1, except that a set firing temperature of heat treatment equipment was set so that a temperature of a reactor in the heat treatment equipment became 825° C., which is a target firing temperature.

### Cathode Active Material According to Experimental Example 6-1

A cathode active material was manufactured in the same manner as in experimental example 1-1, except that W was prepared as a dopant material.

### Cathode Active Material According to Experimental Example 6-2

A cathode active material was manufactured in the same manner as in experimental example 6-1, except that a set firing temperature of heat treatment equipment was set so that a temperature of a reactor in the heat treatment equipment became 750° C., which is a target firing temperature.

### Cathode Active Material According to Experimental Example 6-3

A cathode active material was manufactured in the same manner as in experimental example 6-1, except that a set firing temperature of heat treatment equipment was set so that a temperature of a reactor in the heat treatment equipment became 775° C., which is a target firing temperature.

### Cathode Active Material According to Experimental Example 6-4

A cathode active material was manufactured in the same manner as in experimental example 6-1, except that a set firing temperature of heat treatment equipment was set so that a temperature of a reactor in the heat treatment equipment became 800° C., which is a target firing temperature.

### Cathode Active Material According to Experimental Example 6-5

A cathode active material was manufactured in the same manner as in experimental example 6-1, except that a set firing temperature of heat treatment equipment was set so that a temperature of a reactor in the heat treatment equipment became 825° C., which is a target firing temperature.

### Cathode Active Material According to Experimental Example 6-6

A cathode active material was manufactured in the same manner as in experimental example 6-1, except that a set firing temperature of heat treatment equipment was set so that a temperature of a reactor in the heat treatment equipment became 900° C., which is a target firing temperature.

### Cathode Active Material According to Experimental Example 7-1

A cathode active material was manufactured in the same manner as in experimental example 1-1, except that Mo was prepared as a dopant material and a set firing temperature of heat treatment equipment was set so that a temperature of a reactor in the heat treatment equipment became 700° C., which is a target firing temperature.

### Cathode Active Material According to Experimental Example 7-2

A cathode active material was manufactured in the same manner as in experimental example 7-1, except that a set firing temperature of heat treatment equipment was set so that a temperature of a reactor in the heat treatment equipment became 725° C., which is a target firing temperature.

### Cathode Active Material According to Experimental Example 7-3

A cathode active material was manufactured in the same manner as in experimental example 7-1, except that a set firing temperature of heat treatment equipment was set so that a temperature of a reactor in the heat treatment equipment became 730° C., which is a target firing temperature.

### Cathode Active Material According to Experimental Example 7-4

A cathode active material was manufactured in the same manner as in experimental example 7-1, except that a set firing temperature of heat treatment equipment was set so that a temperature of a reactor in the heat treatment equipment became 750° C., which is a target firing temperature.

### Cathode Active Material According to Experimental Example 7-5

A cathode active material was manufactured in the same manner as in experimental example 7-1, except that a set firing temperature of heat treatment equipment was set so that a temperature of a reactor in the heat treatment equipment became 775° C., which is a target firing temperature.

### Cathode Active Material According to Experimental Example 7-6

A cathode active material was manufactured in the same manner as in experimental example 7-1, except that a set firing temperature of treatment equipment was set so that a temperature of a reactor in the heat treatment equipment became 800° C., which is a target firing temperature.

### Cathode Active Material According to Comparative Example 1-1

A cathode active material was manufactured in the same manner as in experimental example 1-1, except that a dopant material was not provided and a cathode active material precursor and a lithium salt were mixed at a ratio of 1.03:1.00.

### Cathode Active Material According to Comparative Example 1-2

A cathode active material was manufactured in the same manner as in comparative example 1-1, except that a set firing temperature of heat treatment equipment was set so that a temperature of a reactor in the heat treatment equipment became 750° C., which is a target firing temperature.

### Cathode Active Material According to Comparative Example 1-3

A cathode active material was manufactured in the same manner as in comparative example 1-1, except that a set firing temperature of heat treatment equipment was set so that a temperature of a reactor in the heat treatment equipment became 775° C., which is a target firing temperature.

### Cathode Active Material According to Comparative Example 1-4

A cathode active material was manufactured in the same manner as in comparative example 1-1, except that a set firing temperature of heat treatment equipment was set so that a temperature of a reactor in the heat treatment equipment became 800° C., which is a target firing temperature.

TABLE 1

| | Target firing | Dopant |
|---|---|---|
| Classification | temperature (° C.) | material |
| Comparative example 1-1 | 725 | — |
| Comparative example 1-2 | 750 | — |
| Comparative example 1-3 | 775 | — |
| Comparative example 1-4 | 800 | — |
| Experimental example 1-1 | 725 | Nb |
| Experimental example 1-2 | 750 | Nb |
| Experimental example 1-3 | 775 | Nb |
| Experimental example 1-4 | 800 | Nb |
| Experimental example 2-1 | 725 | Ti |
| Experimental example 2-2 | 730 | Ti |
| Experimental example 2-3 | 750 | Ti |
| Experimental example 2-4 | 775 | Ti |
| Experimental example 2-5 | 800 | Ti |
| Experimental example 3-1 | 700 | Zr |
| Experimental example 3-2 | 725 | Zr |
| Experimental example 3-3 | 750 | Zr |
| Experimental example 3-4 | 775 | Zr |
| Experimental example 3-5 | 800 | Zr |
| Experimental example 4-1 | 725 | Hf |
| Experimental example 4-2 | 750 | Hf |
| Experimental example 4-3 | 775 | Hf |
| Experimental example 4-4 | 800 | Hf |
| Experimental example 5-1 | 725 | Ta |
| Experimental example 5-2 | 750 | Ta |
| Experimental example 5-3 | 775 | Ta |
| Experimental example 5-4 | 800 | Ta |
| Experimental example 5-5 | 825 | Ta |
| Experimental example 6-1 | 725 | W |
| Experimental example 6-2 | 750 | W |
| Experimental example 6-3 | 775 | W |
| Experimental example 6-4 | 800 | W |
| Experimental example 6-5 | 825 | W |
| Experimental example 6-6 | 900 | W |
| Experimental example 7-1 | 700 | Mo |
| Experimental example 7-2 | 725 | Mo |
| Experimental example 7-3 | 730 | Mo |
| Experimental example 7-4 | 750 | Mo |
| Experimental example 7-5 | 775 | Mo |
| Experimental example 7-6 | 800 | Mo |

FIG. 8 is a graph for comparing a set firing temperature of heat treatment equipment and an actual temperature in the heat treatment equipment according to an experimental example of the present invention.

Referring to (a) of FIG. 8, an actual temperature at a lower left region of a reactor in heat treatment equipment was measured according to a set firing temperature of the heat treatment equipment according to an experimental example. Referring to (b) of FIG. 8, an actual temperature at a lower right region of the reactor in the heat treatment equipment was measured according to the set temperature of the heat treatment equipment according to an experimental example. Referring to (c) of FIG. 8, an actual temperature at a upper right region of the reactor in the heat treatment equipment was measured according to the set temperature of the heat treatment equipment according to an experimental example. In addition, the actual temperature of the reactor in the heat treatment equipment measured in (a) to (c) of FIG. 8 is summarized in <Table 2> below.

As can be seen from (a) to (c) of FIG. 8, it can be found that the actual temperature of the reactor in the heat treatment equipment is higher than the set temperature of the heat treatment equipment.

Thus, in the method for manufacturing the cathode active material according to the present invention, it can be found that the set temperature of the heat-treatment equipment needs to be set lower than the target firing temperature in order to heat-treat a preliminary cathode active material at a target firing temperature.

TABLE 2

| | Actual | Actual | Actual |
|---|---|---|---|
| | temperature | temperature | temperature |
| Set | (difference | (difference | (difference |
| temperature | value) (Lower | value) (Lower | value) (Upper |
| ° C. | left region) | right region) | right region) |
| 500 | 518 (+18) | 525 (+25) | 511 (+11) |
| 600 | 628 (+28) | 630 (+30) | 624 (+24) |
| 650 | 681 (+31) | 682 (+32) | 678 (+28) |
| 700 | 734 (+34) | 734 (+34) | 730 (+30) |
| 750 | 786 (+36) | 785 (+35) | 781 (+31) |
| 800 | 837 (+37) | 835 (+35) | 832 (+32) |
| 900 | 938 (+38) | 935 (+35) | 930 (+30) |

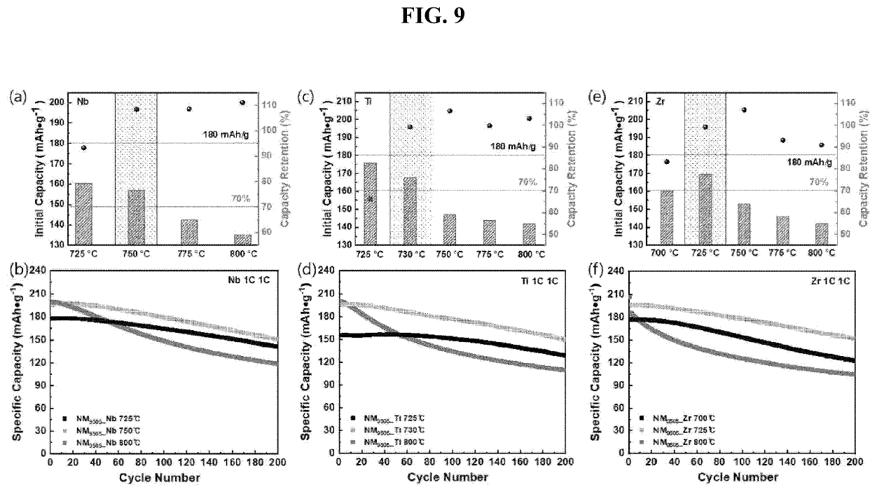

FIGS. 9 to 11 are graphs for comparing an initial capacity of a lithium ion battery with cathode active materials applied thereto, and a capacity retention rate thereof for a charge/discharge cycle according to experimental examples of the present invention.

Referring to (a) and (b) of FIG. 9, an initial capacity of a lithium ion battery with cathode active materials applied thereto, and a capacity retention rate thereof for 200 charge/discharge cycles were measured according to experimental examples 1-1 (NM9505_Nb 725° C.) to 1-4 (NM9505_Nb 800° C.).

As can be seen from (a) and (b) of FIG. 9, it can be found that the initial capacity of the lithium ion battery with the cathode active material applied thereto is 190 mAh/g or more, and the capacity retention rate thereof is 70% or more according to experimental example 1-2 (NM9505_Nb 750° C.). Thus, it can be found that an optimized target firing temperature for an Nb dopant material is 750° C.

Referring to (c) and (d) of FIG. 9, an initial capacity of a lithium ion battery with a cathode active material applied thereto, and a capacity retention rate thereof for 200 charge/discharge cycles were measured according to experimental examples 2-1 (NM9505_Ti 725° C.) to 2-5 (NM9505_Ti 800° C.).

As can be seen from (c) and (d) of FIG. 9, it can be found that the initial capacity of the lithium ion battery with the cathode active material applied thereto is 190 mAh/g or more, and the capacity retention rate thereof is 70% or more according to experimental example 2-2 (NM9505_Ti 730° C.). Thus, it can be found that an optimized target firing temperature for a Ti dopant material is 730° C.

Referring to (e) and (f) of FIG. 9, an initial capacity of a lithium ion battery with a cathode active material applied thereto, and a capacity retention rate thereof for 200 charge/discharge cycles were measured according to experimental examples 3-1 (NM9505_Zr 700° C.) to 3-5 (NM9505_Zr 800° C.).

As can be seen from (e) and (f) of FIG. 9, it can be found that the initial capacity of the lithium ion battery with the cathode active material applied thereto is 190 mAh/g or more, and the capacity retention rate thereof is 70% or more according to experimental example 3-2 (NM9505_Zr 725° C.). Thus, it can be found that an optimized target firing temperature for a Zr dopant material is 725° C.

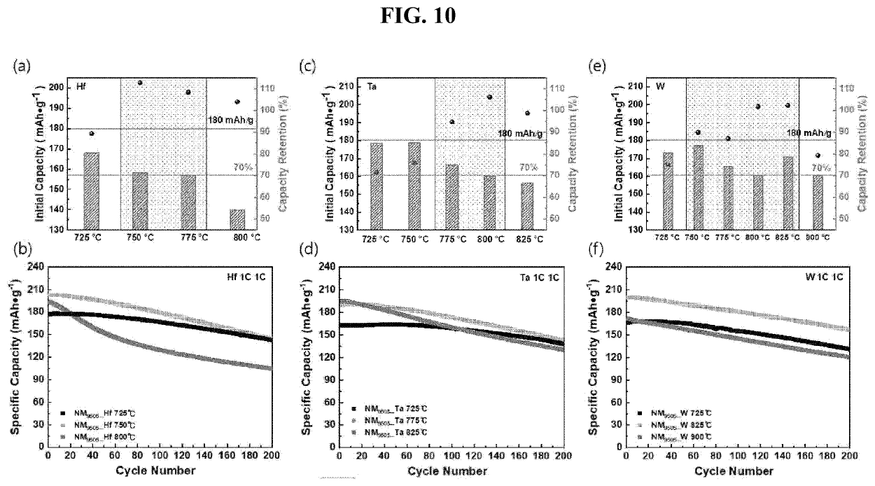

Referring to (a) and (b) of FIG. 10, an initial capacity of a lithium ion battery with cathode active materials applied thereto, and a capacity retention rate thereof for 200 charge/discharge cycles were measured according to experimental examples 4-1 (NM9505_Hf 725° C.) to 4-4 (NM9505_Hf 800° C.).

As can be seen from (a) and (b) of FIG. 10, it can be found that the initial capacity of the lithium ion battery with the cathode active material applied thereto is 190 mAh/g or more, and the capacity retention rate thereof is 70% or more according to experimental example 4-2 (NM9505_Hf 750° C.). Thus, it can be found that an optimized target firing temperature for an Hf dopant material is 750° C.

Referring to (c) and (d) of FIG. 10, an initial capacity of a lithium ion battery with cathode active materials applied thereto, and a capacity retention rate thereof for 200 charge/discharge cycles were measured according to experimental examples 5-1 (NM9505_Ta 725° C.) to 5-5 (NM9505_Ta 825° C.).

As can be seen from (c) and (d) of FIG. 10, it can be found that the initial capacity of the lithium ion battery with the cathode active material applied thereto is 190 mAh/g or more, and the capacity retention rate thereof is 70% or more according to experimental example 5-3 (NM9505_Ta 775° C.). Thus, it can be found that an optimized target firing temperature for a Ta dopant material is 775° C.

Referring to (e) and (f) of FIG. 10, an initial capacity of a lithium ion battery with cathode active materials applied thereto, and a capacity retention rate thereof for 200 charge/discharge cycles were measured according to experimental examples 6-1 (NM9505_W 725° C.) to 6-6 (NM9505_W 900° C.).

As can be seen from (e) and (f) of FIG. 10, it can be found that the initial capacity of the lithium ion battery with the cathode active material applied thereto is 190 mAh/g or more, and the capacity retention rate thereof is 70% or more according to experimental example 6-5 (NM9505_W 825° C.). Thus, it can be found that an optimized target firing temperature for a W dopant material is 825° C.

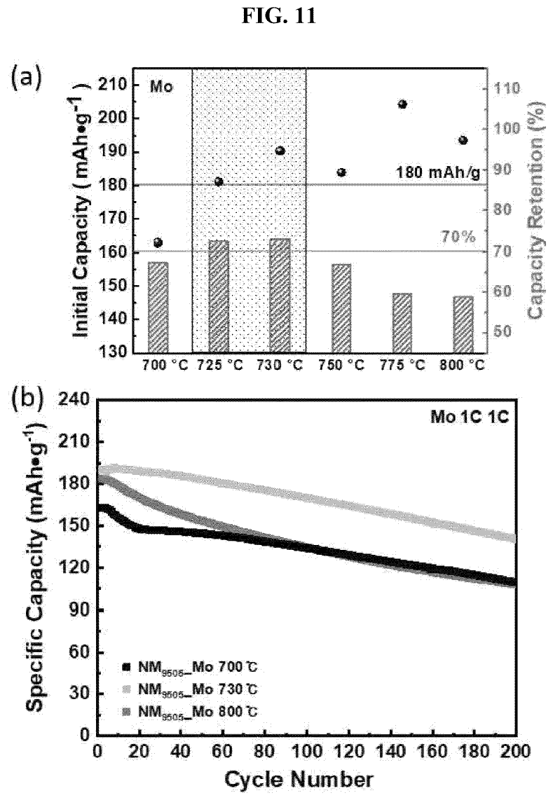

Referring to (a) and (b) of FIG. 11, an initial capacity of a lithium ion battery with cathode active materials applied thereto, and a capacity retention rate thereof for 200 charge/discharge cycles were measured according to experimental examples 7-1 (NM9505_Mo 700° C.) to 7-6 (NM9505_Mo 800° C.).

As can be seen from (a) and (b) of FIG. 11, it can be found that the initial capacity of the lithium ion battery with the cathode active material applied thereto is 190 mAh/g or more, and the capacity retention rate thereof is 70% or more according to experimental example 7-3 (NM9505_Mo 730° C.). Thus, it can be found that an optimized target firing temperature for a Mo dopant material is 730° C.

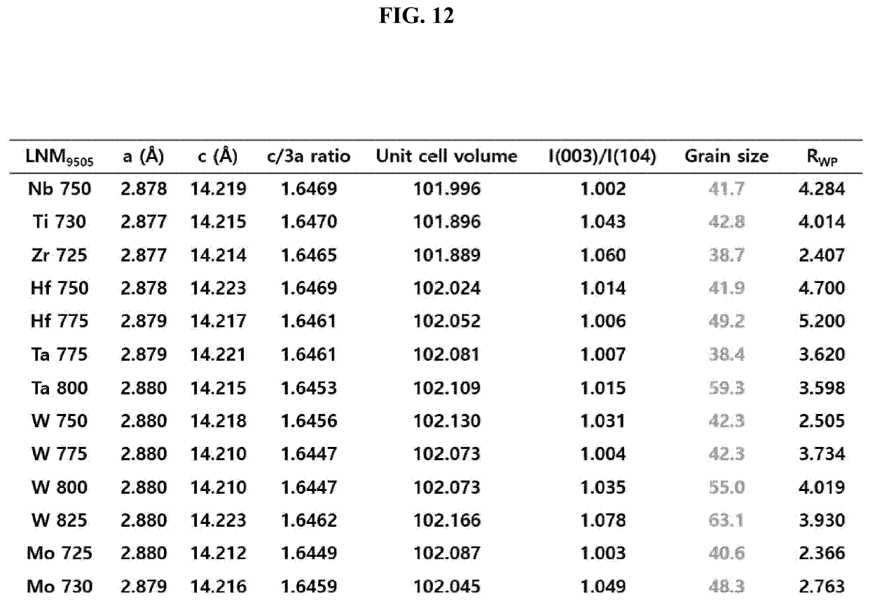

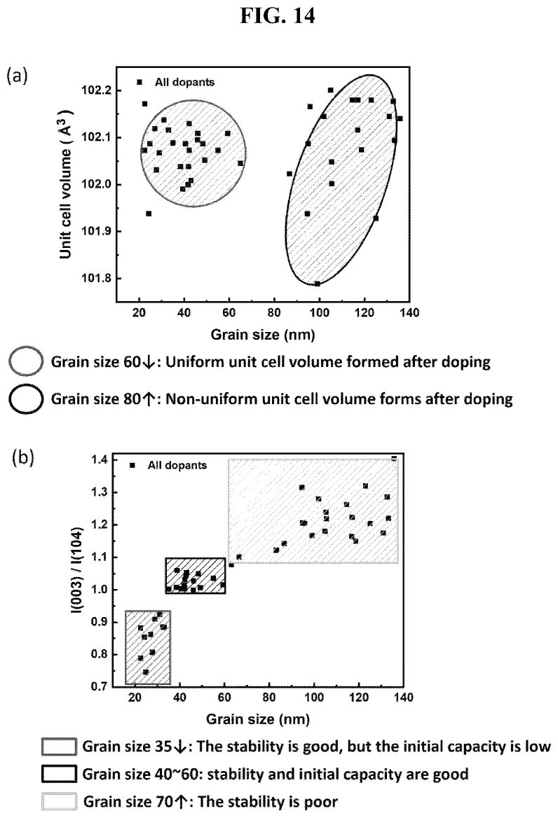

FIG. 12 is a table for comparing results of XRD analysis on cathode active materials according to experimental examples of the present invention, and FIGS. 13 and 14 are graphs for comparing a correlation between a performance of a lithium ion battery with cathode active materials applied thereto, and a grain size of the cathode active materials according to experimental examples of the present invention.

Referring to FIG. 12, cathode active materials were analyzed by XRD Rietveld refinement and summarized in a table according to experimental examples 1-2 (Nb 750), 2-2 (Ti 730), 3-2 (Zr 725), 4-2 (Hf 750), 4-3 (Hf 775), 5-3 (Ta 775), 5-4 (Ta 800), 6-2 (W 750), 6-3 (W 775), 6-4 (W 800), 6-5 (W 825), 7-2 (Mo 725), and 7-3 (Mo 730).

As can be seen from FIG. 12, it can be found that a grain size of the cathode active materials manufactured by heat-treatment at a target firing temperature optimized for each dopant material (Nb, Ti, Zr, Hf, Ta, W, Mo) is 40 nm to 60 nm according to experimental examples 1-1 (Nb 750), 2-2 (Ti 730), 3-2 (Zr 725), 4-2 (Hf 750), 5-3 (Ta 775), 6-5 (W 825), and 7-3 (Mo 730), as described in FIGS. 9 to 11.

Referring to (a) of FIG. 13, a correlation between a capacity retention rate of a lithium ion battery with cathode active materials applied thereto for 200 charge/discharge cycles according to experimental examples 1-1 to 7-6, measured in FIGS. 9 to 11, and a grain size of the cathode active materials according to experimental examples 1-1 to 7-6 is shown in the graph. Referring to (b) of FIG. 13, a correlation between an initial capacity of the lithium ion battery with the cathode active materials applied thereto according to experimental examples 1-1 to 7-6, measured in FIGS. 9 to 11, and a grain size of the cathode active materials according to experimental examples 1-1 to 7-6 is shown in the graph.

As can be seen from (a) and (b) of FIG. 13, it can be found that as the grain size of the cathode active materials according to experimental examples increases, the capacity retention rate of the lithium ion battery with the cathode active materials applied thereto according to experimental examples decreases. In addition, when the grain size of the cathode active materials according to experimental examples is 40 nm or more, it can be found that the initial capacity of the lithium ion battery with the cathode active materials applied thereto according to experimental examples is 180 mAh/g or more.

Referring to (a) of FIG. 14, a correlation between a unit cell volume of the cathode active materials according to experimental examples 1-1 to 7-6, described in FIGS. 9 to 11, and a grain size of the cathode active materials according to experimental examples 1-1 to 7-6 is shown in the graph. Referring to (b) of FIG. 14, a correlation between a ratio (I₍₀₀₃₎/I₍₁₀₄₎) between a peak value (I₍₀₀₃₎) corresponding to a plane (003) and a peak value (I₍₁₀₄₎ corresponding to a plane (104) with respect to the cathode active materials according to experimental examples 1-1 to 7-6, described in FIGS. 9 to 11, and a grain size of the cathode active materials according to experimental examples 1-1 to 7-6 is shown in the graph. In addition, I₍₀₀₃₎/I₍₁₀₄₎ according to experimental examples 1-1 to 7-6 and the grain size are summarized in <Table 3> below.

As can be seen from (a) and (b) of FIG. 14, it can be found that when the grain size of the cathode active materials according to experimental examples is 60 nm or less, the unit cell volume of the cathode active materials is uniformly formed. In addition, it can be found that when the grain size of the cathode active materials according to experimental examples is 40 nm or more and 60 nm or less, I₍₀₀₃₎/I₍₁₀₄₎ is more than 1.0 and less than 1.1. In this case, it can be found that the initial capacity of the lithium ion battery with the cathode active material applied thereto, and the capacity retention rate thereof for charge/discharge cycles are improved. On the contrary, it can be found that when the grain size of the cathode active material is 35 nm or less, the initial capacity of the lithium ion battery with the cathode active material applied thereto is reduced. On the other hand, it can be found that when the grain size of the cathode active material is 70 nm or less, the capacity retention rate of the lithium ion battery with the cathode active material thereto for charge/discharge cycles is applied is reduced.

Thus, in the method for manufacturing the cathode active material according to the present invention, it can be found that the method for manufacturing the cathode active material by firing the preliminary cathode active material at an optimized target firing temperature for a dopant material is a method for improving the initial capacity of the lithium ion battery with the cathode active material applied thereto, and the capacity retention rate thereof for charge/discharge cycles by controlling the grain size of the cathode active material to be 40 nm or more and 60 nm or less.

TABLE 3

| | Target firing | | Grain | |
|---|---|---|---|---|
| | temperature | I₍₀₀₃₎/ | size | Dopant |
| Classification | (° C.) | I₍₁₀₄₎ | (nm) | material |
| Experimental example 1-1 | 725 | 0.746 | 24.8 | Nb |
| Experimental example 1-2 | 750 | 1.002 | 41.7 | Nb |
| Experimental example 1-3 | 775 | 1.230 | 103.4 | Nb |
| Experimental example 1-4 | 800 | 1.164 | 116.9 | Nb |
| Experimental example 2-1 | 725 | 0.884 | 33.0 | Ti |
| Experimental example 2-2 | 730 | 1.043 | 42.8 | Ti |
| Experimental example 2-3 | 750 | 1.315 | 94.6 | Ti |
| Experimental example 2-4 | 775 | 1.219 | 105.5 | Ti |
| Experimental example 2-5 | 800 | 1.150 | 118.6 | Ti |
| Experimental example 3-1 | 700 | 0.799 | 22.8 | Zr |
| Experimental example 3-2 | 725 | 1.060 | 38.7 | Zr |
| Experimental example 3-3 | 750 | 1.206 | 94.9 | Zr |
| Experimental example 3-4 | 775 | 1.263 | 114.6 | Zr |
| Experimental example 3-5 | 800 | 1.320 | 123.0 | Zr |
| Experimental example 4-1 | 725 | 0.807 | 27.7 | Hf |
| Experimental example 4-2 | 750 | 1.014 | 41.9 | Hf |
| Experimental example 4-3 | 775 | 1.006 | 49.2 | Hf |
| Experimental example 4-4 | 800 | 1.175 | 130.9 | Hf |
| Experimental example 5-1 | 725 | 0.853 | 24.2 | Ta |
| Experimental example 5-2 | 750 | 0.862 | 27.0 | Ta |
| Experimental example 5-3 | 775 | 1.007 | 38.4 | Ta |
| Experimental example 5-4 | 800 | 1.015 | 59.3 | Ta |
| Experimental example 5-5 | 825 | 1.122 | 83.2 | Ta |
| Experimental example 6-1 | 725 | 0.882 | 22.4 | W |
| Experimental example 6-2 | 750 | 1.031 | 42.3 | W |
| Experimental example 6-3 | 775 | 1.004 | 42.3 | W |
| Experimental example 6-4 | 800 | 1.035 | 55.0 | W |
| Experimental example 6-5 | 825 | 1.078 | 63.1 | W |
| Experimental example 6-6 | 900 | 1.065 | 114.7 | W |
| Experimental example 7-1 | 700 | 0.765 | 21.7 | Mo |
| Experimental example 7-2 | 725 | 1.003 | 40.6 | Mo |
| Experimental example 7-3 | 730 | 1.049 | 48.3 | Mo |
| Experimental example 7-4 | 750 | 1.101 | 66.5 | Mo |
| Experimental example 7-5 | 775 | 1.142 | 86.7 | Mo |
| Experimental example 7-6 | 800 | 1.280 | 101.9 | Mo |

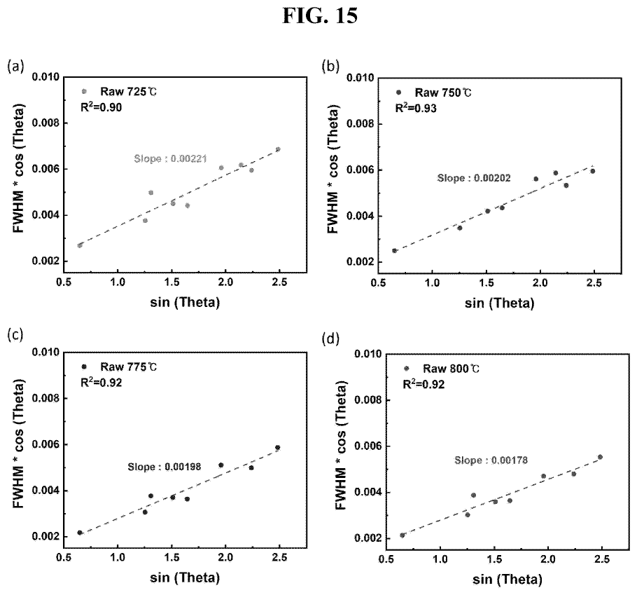

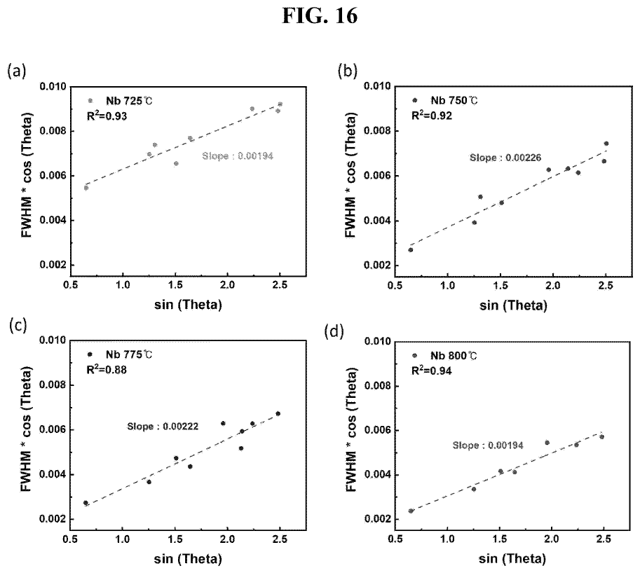

FIG. 15 is a graph for comparing the W-H Plot of cathode active materials according to comparative examples of the present invention, and FIGS. 16 to 22 are graphs for comparing the W-H Plot of cathode active materials according to experimental examples of the present invention.

Referring to (a) of FIG. 15, the W-H Plot for the cathode active material according to comparative example 1-1 (Raw 725° C.) was shown using the results of XRD analysis on the cathode active material according to comparative example 1-1 (Raw 725° C.). Referring to (b) of FIG. 15, the W-H Plot for the cathode active material according to comparative example 1-2 (Raw 750° C.) was shown using the results of XRD analysis on the cathode active material according to comparative example 1-2 (Raw 750° C.). Referring to (c) of FIG. 15, the W-H Plot for the cathode active material according to comparative example 1-3 (Raw 775° C.) was shown using the results of XRD analysis on the cathode active material according to comparative example 1-3 (Raw 775° C.). Referring to (d) of FIG. 15, the W-H Plot for the cathode active material according to comparative example 1-4 (Raw 800° C.) was shown using the results of XRD analysis on the cathode active material according to comparative example 1-4 (Raw 800° C.). In addition, the slope for W-H Plot was calculated in (a) to (d) of FIG. 15 and summarized in <Table 4> below.

As can be seen from (a) to (d) of FIG. 15, it can be found that as the target firing temperature for the preliminary cathode active material without a doping material added thereto increases, a growth of the particles of the manufactured cathode active material becomes uniform and the directivity of the particles becomes constant. Accordingly, it can be found that the stress applied to the crystal structure of the cathode active material is reduced, and thus the slope on the W-H Plot is reduced.

TABLE 4

| | Target firing | | Legend |
|---|---|---|---|
| Classification | temperature | Slope | in graph |
| Comparative example 1-1 | 725 | 0.00221 | Raw 725° C. |
| Comparative example 1-2 | 750 | 0.00202 | Raw 750° C. |
| Comparative example 1-3 | 775 | 0.00198 | Raw 775° C. |
| Comparative example 1-4 | 800 | 0.00178 | Raw 800° C. |

Referring to (a) of FIG. 16, the W-H Plot for the cathode active material according to experimental example 1-1 (Nb 725° C.) was shown using the results of XRD analysis on the cathode active material according to experimental example 1-1 (Nb 725° C.). Referring to (b) of FIG. 16, the W-H Plot for the cathode active material according to experimental example 1-2 (Nb 750° C.) was shown using the results of XRD analysis on the cathode active material according to experimental example 1-2 (Nb 750° C.). Referring to (c) of FIG. 16, the W-H Plot for the cathode active material according to experimental example 1-3 (Nb 775° C.) was shown using the results of XRD analysis on the cathode active material according to experimental example 1-3 (Nb 775° C.). Referring to (d) of FIG. 16, the W-H Plot for the cathode active material according to experimental example 1-4 (Nb 800° C.) was shown using the results of XRD analysis on the cathode active material according to experimental example 1-4 (Nb 800° C.). In addition, the slope for the W-H Plot was calculated in (a) to (d) of FIG. 16 and summarized in <Table 5> below.

As can be seen from (a) to (d) of FIG. 16, it can be found that the cathode active material according to experimental example 1-2 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 5

| | Target firing | | Legend |
|---|---|---|---|
| Classification | temperature | Slope | in graph |
| Experimental example 1-1 | 725 | 0.00194 | Nb 725° C. |
| Experimental example 1-2 | 750 | 0.00226 | Nb 750° C. |
| Experimental example 1-3 | 775 | 0.00222 | Nb 775° C. |
| Experimental example 1-4 | 800 | 0.00194 | Nb 800° C. |

Referring to (a) of FIG. 17, the W-H Plot for the cathode active material according to experimental example 2-1 (Ti 725° C.) was shown using the results of XRD analysis on the cathode active material according to experimental example 2-1 (Ti 725° C.). Referring to (b) of FIG. 17, the W-H Plot for the cathode active material according to experimental example 2-2 (Ti 730° C.) was shown using the results of XRD analysis on the cathode active material according to experimental example 2-2 (Ti 730° C.). Referring to (c) of FIG. 17, the W-H Plot for the cathode active material according to experimental example 2-3 (Ti 750° C.) was shown using the results of XRD analysis on the cathode active material according to experimental example 2-3 (Ti 750° C.). Referring to (d) of FIG. 17, the W-H Plot for the cathode active material according to experimental example 2-4 (Ti 775° C.) was shown using the results of XRD analysis on the cathode active material according to experimental example 2-4 (Ti 775° C.). Referring to (e) of FIG. 17, the W-H Plot for the cathode active material according to experimental example 2-5 (Ti 800° C.) was shown using the results of XRD analysis on the cathode active material according to experimental example 2-5 (Ti 800° C.). In addition, the slope for the W-H Plot was calculated in (a) to (e) of FIG. 17 and summarized in <Table 6> below.

As can be seen from (a) to (e) of FIG. 17, it can be found that the cathode active material according to experimental example 2-2 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 6

| | Target firing | | Legend |
|---|---|---|---|
| Classification | temperature | Slope | in graph |
| Experimental example 2-1 | 725 | 0.00253 | Ti 725° C. |
| Experimental example 2-2 | 730 | 0.00259 | Ti 730° C. |
| Experimental example 2-3 | 750 | 0.00213 | Ti 750° C. |
| Experimental example 2-4 | 775 | 0.00202 | Ti 775° C. |
| Experimental example 2-5 | 800 | 0.00223 | Ti 800° C. |

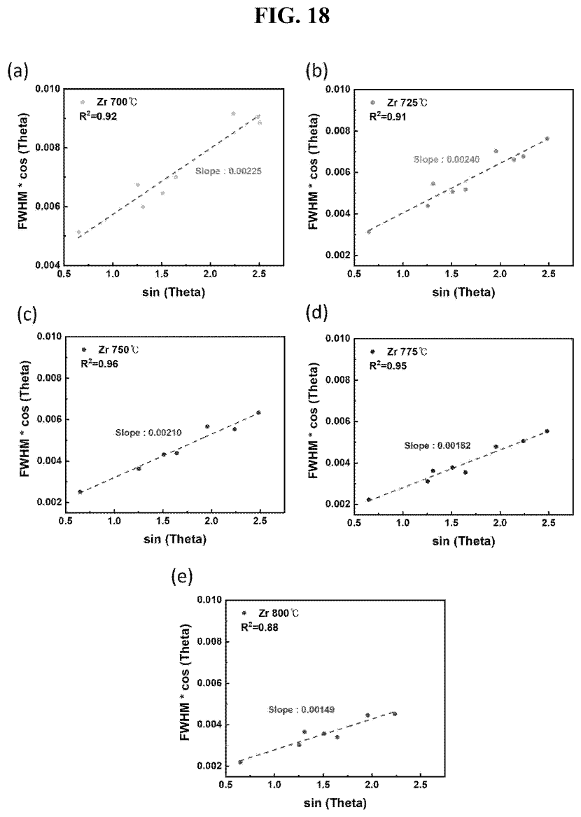

Referring to (a) of FIG. 18, the W-H Plot for the cathode active material according to experimental example 3-1 (Zr 700° C.) was shown using the results of XRD analysis on the cathode active material according to experimental example 3-1 (Zr 700° C.). Referring to (b) of FIG. 18, the W-H Plot for the cathode active material according to experimental example 3-2 (Zr 725° C.) was shown using the results of XRD analysis on the cathode active material according to experimental example 3-2 (Zr 725° C.). Referring to (c) of FIG. 18, the W-H Plot for the cathode active material according to experimental example 3-3 (Zr 750° C.) was shown using the results of XRD analysis on the cathode active material according to experimental example 3-3 (Zr 750° C.). Referring to (d) of FIG. 18, the W-H Plot for the cathode active material according to experimental example 3-4 (Zr 775° C.) was shown using the results of XRD analysis on the cathode active material according to experimental example 3-4 (Zr 775° C.). Referring to (e) of FIG. 18, the W-H Plot for the cathode active material according to experimental example 3-5 (Zr 800° C.) was shown using the results of XRD analysis on the cathode active material according to experimental example 3-5 (Zr 800° C.). In addition, the slope for the W-H Plot was calculated in (a) to (e) of FIG. 18 and summarized in <Table 7> below.

As can be seen from (a) to (e) of FIG. 18, it can be found that the cathode active material according to experimental example 3-2 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 7

| | Target firing | | Legend |
|---|---|---|---|
| Classification | temperature | Slope | in graph |
| Experimental example 3-1 | 700 | 0.00225 | Zr 700° C. |
| Experimental example 3-2 | 725 | 0.00240 | Zr 725° C. |
| Experimental example 3-3 | 750 | 0.00210 | Zr 750° C. |
| Experimental example 3-4 | 775 | 0.00182 | Zr 775° C. |
| Experimental example 3-5 | 800 | 0.00149 | Zr 800° C. |

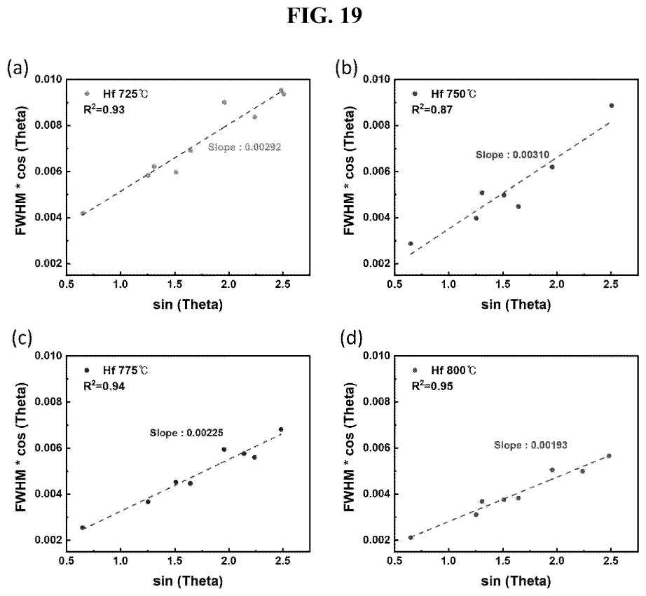

Referring to (a) of FIG. 19, the W-H Plot for the cathode active material according to experimental example 4-1 (Hf 725° C.) was shown using the results of XRD analysis on the cathode active material according to experimental example 4-1 (Hf 725° C.). Referring to (b) of FIG. 19, the W-H Plot for the cathode active material according to experimental example 4-2 (Hf 750° C.) was shown using the results of XRD analysis on the cathode active material according to experimental example 4-2 (Hf 750° C.). Referring to (c) of FIG. 19, the W-H Plot for the cathode active material according to experimental example 4-3 (Hf 775° C.) was shown using the results of XRD analysis on the cathode active material according to experimental example 4-3 (Hf 775° C.). Referring to (d) of FIG. 19, the W-H Plot for the cathode active material according to experimental example 4-4 (Hf 800° C.) was shown using the results of XRD analysis on the cathode active material according to experimental example 4-4 (Hf 800° C.). In addition, the slope for the W-H Plot was calculated in (a) to (d) of FIG. 19 and summarized in <Table 8> below.

As can be seen from (a) to (d) of FIG. 19, it can be found that the cathode active material according to experimental example 4-2 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 8

| | Target firing | | Legend |
|---|---|---|---|
| Classification | temperature | Slope | in graph |
| Experimental example 4-1 | 725 | 0.00292 | Hf 725° C. |
| Experimental example 4-2 | 750 | 0.00310 | Hf 750° C. |
| Experimental example 4-3 | 777 | 0.00225 | Hf 775° C. |
| Experimental example 4-4 | 800 | 0.00193 | Hf 800° C. |

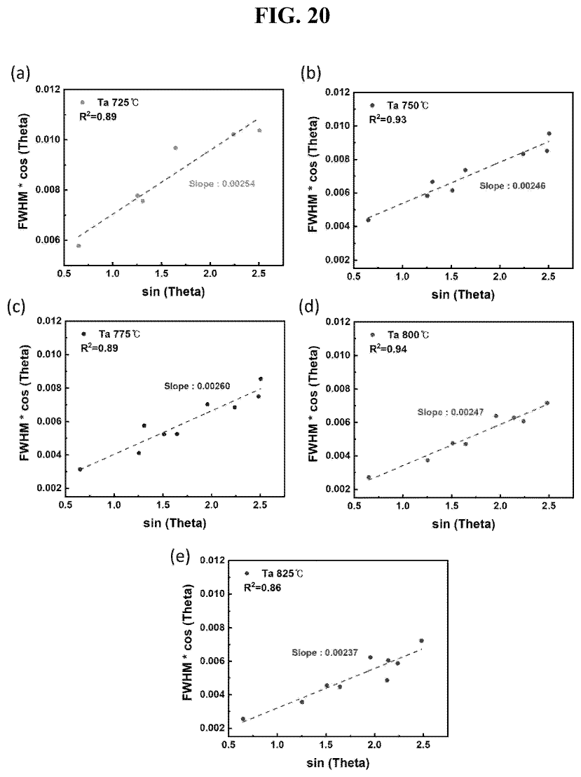

Referring to (a) of FIG. 20, the W-H Plot for the cathode active material according to experimental example 5-1 (Ta 725° C.) was shown using the results of XRD analysis on the cathode active material according to experimental example 5-1 (Ta 725° C.). Referring to (b) of FIG. 20, the W-H Plot for the cathode active material according to experimental example 5-2 (Ta 750° C.) was shown using the results of XRD analysis on the cathode active material according to experimental example 5-2 (Ta 750° C.). Referring to (c) of FIG. 20, the W-H Plot for the cathode active material according to experimental example 5-3 (Ta 775° C.) was shown using the results of XRD analysis on the cathode active material according to experimental example 5-3 (Ta 775° C.). Referring to (d) of FIG. 20, the W-H Plot for the cathode active material according to experimental example 5-4 (Ta 800° C.) was shown using the results of XRD analysis on the cathode active material according to experimental example 5-4 (Ta 800° C.). Referring to (e) of FIG. 20, the W-H Plot for the cathode active material according to experimental example 5-5 (Zr 825° C.) was shown using the results of XRD analysis on the cathode active material according to experimental example 5-5 (Zr 825° C.). In addition, the slope for the W-H Plot was calculated in (a) to (e) of FIG. 20 and summarized in <Table 9> below.

As can be seen from (a) to (e) of FIG. 20, it can be found that the cathode active material according to experimental example 5-3 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 9

| | Target firing | | Legend |
|---|---|---|---|
| Classification | temperature | Slope | in graph |
| Experimental example 5-1 | 725 | 0.00254 | Ta 725° C. |
| Experimental example 5-2 | 750 | 0.00246 | Ta 750° C. |
| Experimental example 5-3 | 775 | 0.00260 | Ta 775° C. |
| Experimental example 5-4 | 800 | 0.00247 | Ta 800° C. |
| Experimental example 5-5 | 825 | 0.00237 | Ta 825° C. |

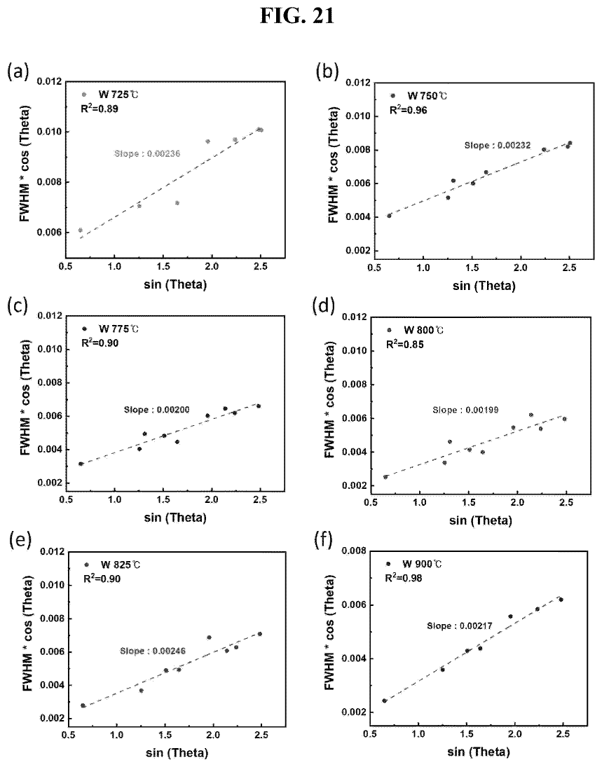

Referring to (a) of FIG. 21, the W-H Plot for the cathode active material according to experimental example 6-1 (W 725° C.) was shown using the results of XRD analysis on the cathode active material according to experimental example 6-1 (W 725° C.). Referring to (b) of FIG. 21, the W-H Plot for the cathode active material according to experimental example 6-2 (W 750° C.) was shown using the results of XRD analysis on the cathode active material according to experimental example 6-2 (W 750° C.). Referring to (c) of FIG. 21, the W-H Plot for the cathode active material according to experimental example 6-3 (W 775° C.) was shown using the results of XRD analysis on the cathode active material according to experimental example 6-3 (W 775° C.). Referring to (d) of FIG. 21, the W-H Plot for the cathode active material according to experimental example 6-4 (W 800° C.) was shown using the results of XRD analysis on the cathode active material according to experimental example 6-4 (W 800° C.). Referring to (e) of FIG. 21, the W-H Plot for the cathode active material according to experimental example 6-5 (W 825° C.) was shown using the results of XRD analysis on the cathode active material according to experimental example 6-5 (W 825° C.). Referring to (f) of FIG. 21, the W-H Plot for the cathode active material according to experimental example 6-6 (W 900° C.) was shown using the results of XRD analysis on the cathode active material according to experimental example 6-6 (W 900° C.). In addition, the slope for the W-H Plot was calculated in (a) to (f) of FIG. 21 and summarized in <Table 10> below.

As can be seen from (a) to (f) of FIG. 21, it can be found that the cathode active material according to experimental example 6-5 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 10

| | Target firing | | Legend |
|---|---|---|---|
| Classification | temperature | Slope | in graph |
| Experimental example 6-1 | 725 | 0.00236 | W 725° C. |
| Experimental example 6-2 | 750 | 0.00232 | W 750° C. |
| Experimental example 6-3 | 775 | 0.00200 | W 775° C. |
| Experimental example 6-4 | 800 | 0.00199 | W 800° C. |
| Experimental example 6-5 | 825 | 0.00246 | W 825° C. |
| Experimental example 6-6 | 900 | 0.00217 | W 900° C. |

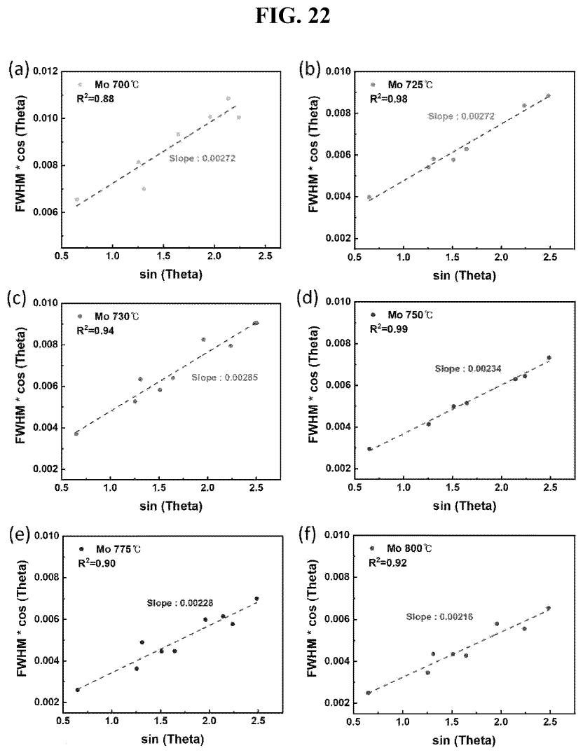

Referring to (a) of FIG. 22, the W-H Plot for the cathode active material according to experimental example 7-1 (Mo 700° C.) was shown using the results of XRD analysis on the cathode active material according to experimental example 7-1 (Mo 700° C.). Referring to (b) of FIG. 22, the W-H Plot for the cathode active material according to experimental example 7-2 (Mo 725° C.) was shown using the results of XRD analysis on the cathode active material according to experimental example 7-2 (Mo 725° C.). Referring to (c) of FIG. 22, the W-H Plot for the cathode active material according to experimental example 7-3 (Mo 730° C.) was shown using the results of XRD analysis on the cathode active material according to experimental example 7-3 (Mo 730° C.). Referring to (d) of FIG. 22, the W-H Plot for the cathode active material according to experimental example 7-4 (Mo 750° C.) was shown using the results of XRD analysis on the cathode active material according to experimental example 7-4 (Mo 750° C.). Referring to (e) of FIG. 22, the W-H Plot for the cathode active material according to experimental example 7-5 (Mo 775° C.) was shown using the results of XRD analysis on the cathode active material according to experimental example 7-5 (Mo 775° C.). Referring to (f) of FIG. 22, the W-H Plot for the cathode active material according to experimental example 7-6 (Mo 800° C.) was shown using the results of XRD analysis on the cathode active material according to experimental example 7-6 (Mo 800° C.). In addition, the slope for the W-H Plot was calculated in (a) to (f) of FIG. 22 and summarized in <Table 11> below.

As can be seen from (a) to (f) of FIG. 22, it can be found that the cathode active material according to experimental example 7-3 has the largest slope with respect to the W-H Plot. This factor may be interpreted as being due to the fact that stress was applied to a plane (104) during the firing process of the preliminary cathode active material. Accordingly, it can be found that the particles of the cathode active material grow to a plane (003) among the plane (003) and the plane (104).

TABLE 11

| | Target firing | | Legend |
|---|---|---|---|
| Classification | temperature (° C.) | Slope | in graph |
| Experimental example 7-1 | 700 | 0.00272 | Mo 700° C. |
| Experimental example 7-2 | 725 | 0.00272 | Mo 725° C. |
| Experimental example 7-3 | 730 | 0.00285 | Mo 730° C. |
| Experimental example 7-4 | 750 | 0.00234 | Mo 750° C. |
| Experimental example 7-5 | 775 | 0.00228 | Mo 775° C. |
| Experimental example 7-6 | 800 | 0.00216 | Mo 800° C. |

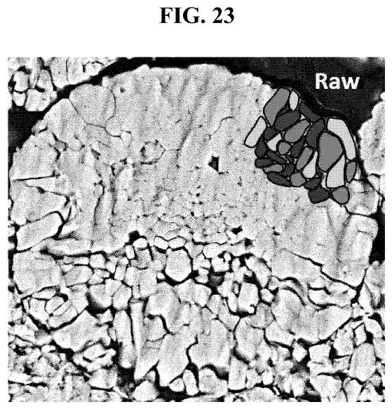

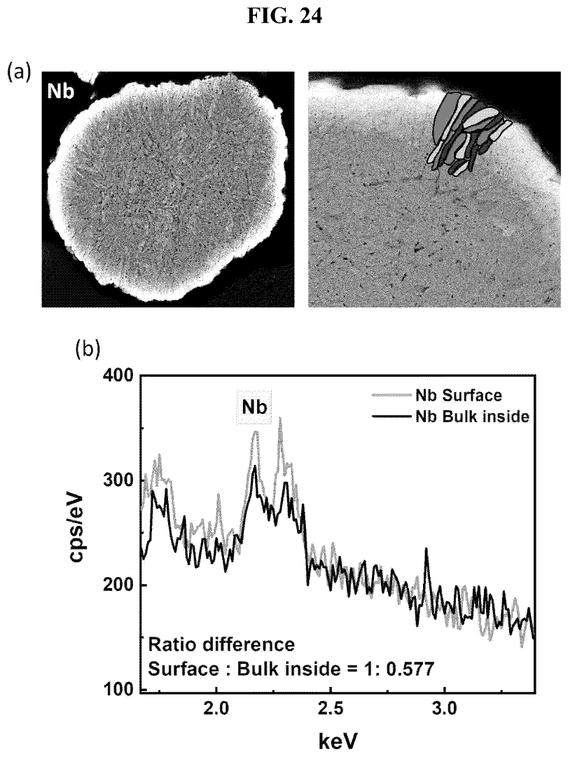

FIG. 23 is an SEM picture of a cathode active material according to comparative example 1-1 of the present invention, and FIGS. 24 to 30 are SEM pictures of cathode active materials and graphs for comparing results of EDS mapping analysis according to experimental examples of the present invention.

Referring to FIG. 23, a section of the cathode active material according to comparative example 1-1 was photographed using an SEM.

As can be seen from FIG. 23, it can be found that the primary particle of the cathode active material according to comparative example 1-1 has a circular shape, and a size of the primary particle increases from the inside to the surface of the cathode active material.

Referring to (a) of FIG. 24, a section of the cathode active material according to experimental example 1-2 was photographed using an SEM. Referring to (b) of FIG. 24, an EDS mapping analysis was performed on a dopant of the cathode active material according to experimental example 1-2.

As can be seen from (a) and (b) of FIG. 24, it can be found that the surface of the cathode active material according to experimental example 1-2 has a primary particle having a rod shape, and a ratio of the primary particle having the rod shape decreases from the surface to the inside of the cathode electrode active material. This factor may be interpreted as being due to the fact that the surface of the cathode active material according to experimental example 1-2 is doped with a dopant at a higher ratio than in the inside.

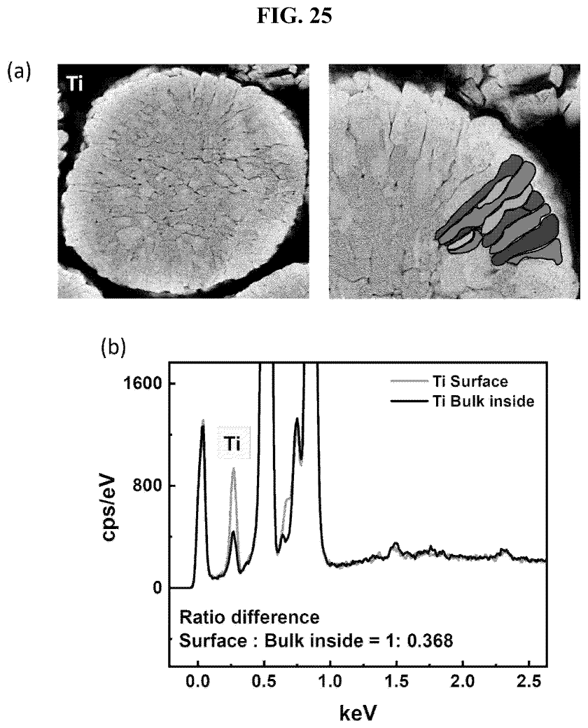

Referring to (a) of FIG. 25, a section of the cathode active material according to experimental example 2-2 was photographed using an SEM. Referring to (b) of FIG. 25, an EDS mapping was performed on a dopant of the cathode active material according to experimental example 2-2.

As can be seen from (a) and (b) of FIG. 25, it can be found that the surface of the cathode active material according to experimental example 2-2 has a primary particle having a rod shape, and a ratio of the primary particle having the rod shape decreases from the surface to the inside of the cathode electrode active material. This factor may be interpreted as being due to the fact that the surface of the cathode active material according to experimental example 2-2 is doped with a dopant at a higher ratio than in the inside.

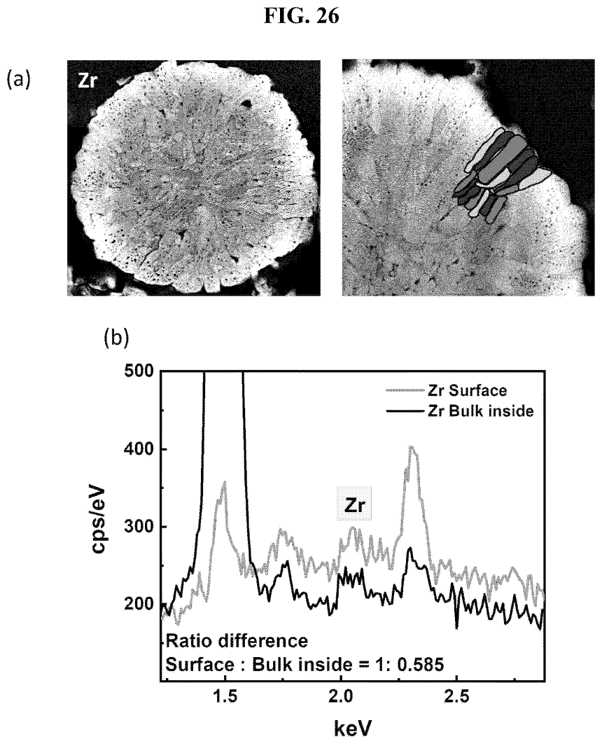

Referring to (a) of FIG. 26, a section of the cathode active material according to experimental example 3-2 was photographed using an SEM. Referring to (b) of FIG. 26, an EDS mapping was performed on a dopant of the cathode active material according to experimental example 3-2.

As can be seen from (a) and (b) of FIG. 26, it can be found that the surface of the cathode active material according to experimental example 3-2 has a primary particle having a rod shape, and a ratio of the primary particle having the rod shape decreases from the surface to the inside of the cathode electrode active material. This factor may be interpreted as being due to the fact that the surface of the cathode active material according to experimental example 3-2 is doped with a dopant at a higher ratio than in the inside.

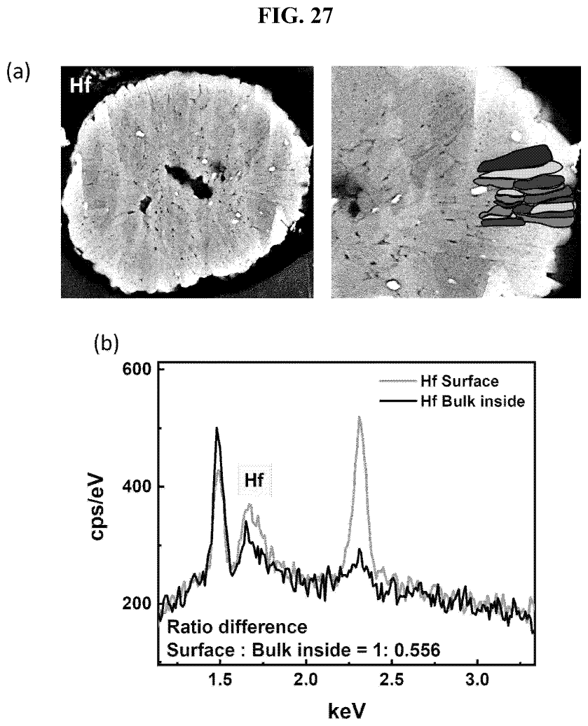

Referring to (a) of FIG. 27, a section of the cathode active material according to experimental example 4-2 was photographed using an SEM. Referring to (b) of FIG. 27, an EDS mapping was performed on a dopant of the cathode active material according to experimental example 4-2.

As can be seen from (a) and (b) of FIG. 27, it can be found that the surface of the cathode active material according to experimental example 4-2 has a primary particle having a rod shape, and a ratio of the primary particle having the rod shape decreases from the surface to the inside of the cathode electrode active material. This factor may be interpreted as being due to the fact that the surface of the cathode active material according to experimental example 4-2 is doped with a dopant at a higher ratio than in the inside.

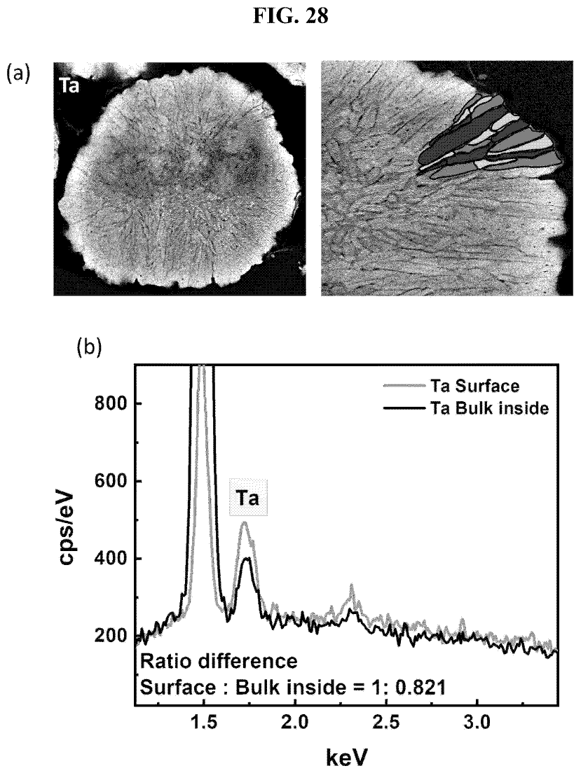

Referring to (a) of FIG. 28, a section of the cathode active material according to experimental example 5-3 was photographed using an SEM. Referring to (b) of FIG. 28, an EDS mapping was performed on a dopant of the cathode active material according to experimental example 5-3.

As can be seen from (a) to (b) of FIG. 28, it can be found that the surface and inside of the cathode active material according to experimental example 5-2 are similar in the ratio of primary particles having the rod shape. This factor may be interpreted as being due to the fact that the dopant is doped at a similar ratio on the surface and inside of the cathode active material according to experimental example 5-2.

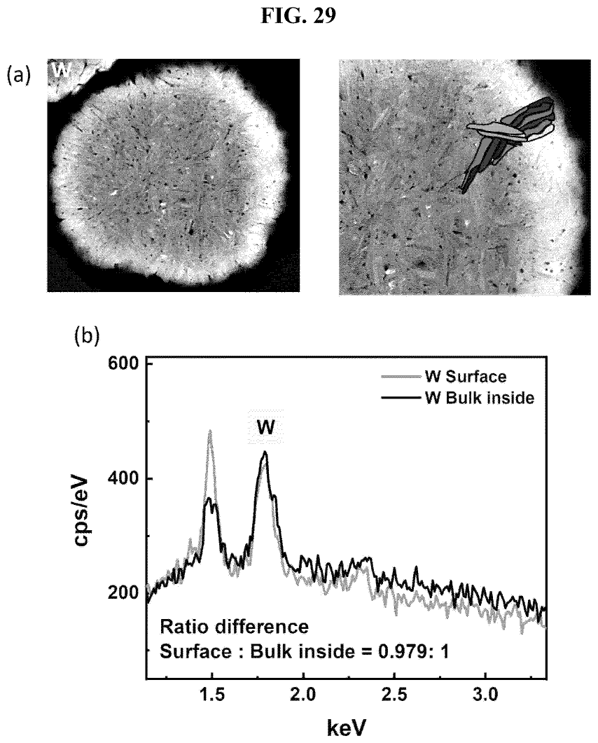

Referring to (a) of FIG. 29, a section of the cathode active material according to experimental example 6-5 was photographed using an SEM. Referring to (b) of FIG. 29, an EDS mapping was performed on a dopant of the cathode active material according to experimental example 6-5.

As can be seen from (a) to (b) of FIG. 29, it can be found that the surface and inside of the cathode active material according to experimental example 6-5 are similar in the ratio of primary particles having the rod shape. This factor may be interpreted as being due to the fact that the dopant is doped at a similar ratio on the surface and inside of the cathode active material according to experimental example 6-5.

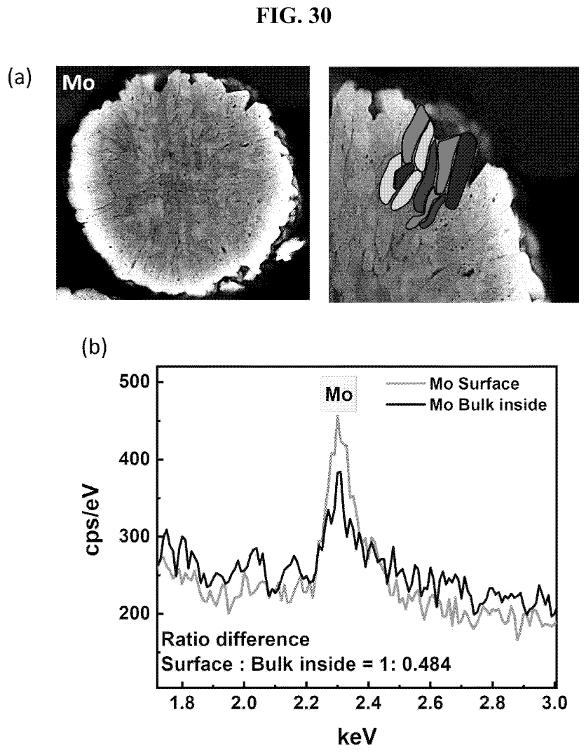

Referring to (a) of FIG. 30, a section of the cathode active material according to experimental example 7-3 was photographed using an SEM. Referring to (b) of FIG. 30, an EDS mapping was performed on a dopant of the cathode active material according to experimental example 7-3.

As can be seen from (a) and (b) of FIG. 30, it can be found that the surface of the cathode active material according to experimental example 7-3 has a primary particle having a rod shape, and a ratio of the primary particle having the rod shape decreases from the surface to the inside of the cathode electrode active material. This factor may be interpreted as being due to the fact that the surface of the cathode active material according to experimental example 7-3 is doped with a dopant at a higher ratio than in the inside.

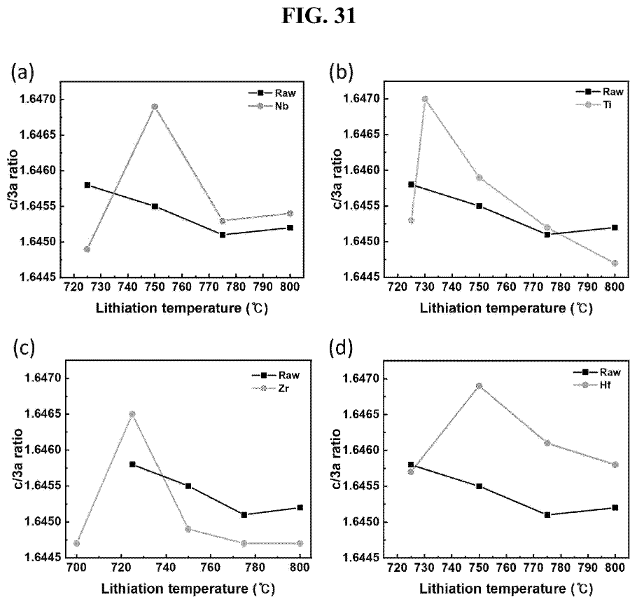

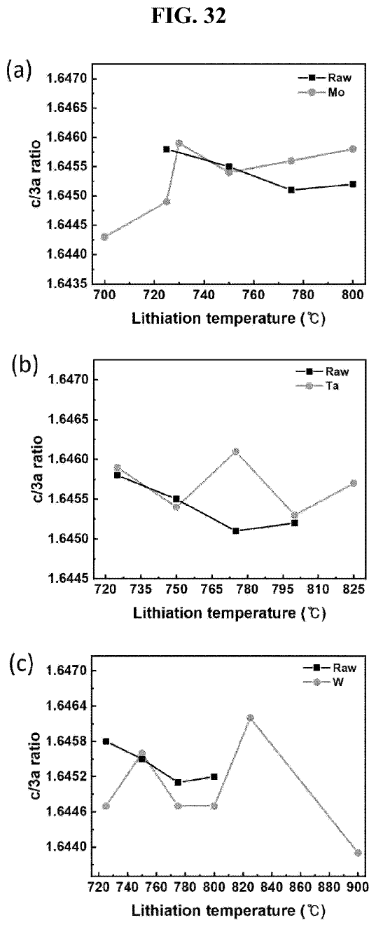

FIGS. 31 and 32 are graphs for comparing the crystal stability of cathode active materials according to comparative and experimental examples of the present invention.

Referring to (a) of FIG. 31, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 1-1 (725° C.) to 1-4 (800° C.) to show a c/3a ratio in a graph.

As can be seen from (a) of FIG. 31, it can be found that the cathode active material according to experimental example 2-2 (750° C.) has a highest c/3a ratio. Accordingly, it can be found that the cathode active material according to experimental example 2-2 (750° C.) has the most excellent crystal stability. Thus, in the method for manufacturing the cathode active material according to the present invention, it can be found that the method for firing a transition metal hydroxide, a lithium salt, and a Nb dopant material at more than 725° C. and less than 775° C. is a method for improving the crystal stability of the cathode active material.

Referring to (b) of FIG. 31, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 2-1 (725° C.) to 2-5 (800° C.) to show a c/3a ratio in a graph.

As can be seen from (b) of FIG. 31, it can be found that the cathode active material according to experimental example 2-2 (730° C.) has a highest c/3a ratio. Accordingly, it can be found that the cathode active material according to experimental example 2-2 (730° C.) has the most excellent crystal stability. Thus, in the method for manufacturing the cathode active material according to the present invention, it can be found that the method for firing a transition metal hydroxide, a lithium salt, and a Ti dopant material at more than 725° C. and less than 750° C. is a method for improving the crystal stability of the cathode active material by controlling c/3a of the cathode active material to exceed 1.6459.

Referring to (c) of FIG. 31, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 3-1 (700° C.) to 3-5 (800° C.) to show a c/3a ratio in a graph.

As can be seen from (c) of FIG. 31, it can be found that the cathode active material according to experimental example 3-2 (725° C.) has a highest c/3a ratio. Accordingly, it can be found that the cathode active material according to experimental example 3-2 (725° C.) has the most excellent crystal stability. Thus, in the method for manufacturing the cathode active material according to the present invention, it can be found that the method for firing a transition metal hydroxide, a lithium salt, and a Zr dopant material at more than 700° C. and less than 750° C. is a method for improving the crystal stability of the cathode active material.

Referring to (d) of FIG. 31, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 4-1 (725° C.) to 4-4 (800° C.) to show a c/3a ratio in a graph.

As can be seen from (d) of FIG. 31, it can be found that the cathode active material according to experimental example 4-2 (750° C.) has a highest c/3a ratio. Accordingly, it can be found that the cathode active material according to experimental example 4-2 (750° C.) has the most excellent crystal stability. Thus, in the method for manufacturing the cathode active material according to the present invention, it can be found that the method for firing a transition metal hydroxide, a lithium salt, and a Hf dopant material at more than 725° C. and less than 775° C. is a method for improving the crystal stability of the cathode active material.

Referring to (a) of FIG. 32, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 7-1 (700° C.) to 7-6 (800° C.) to show a c/3a ratio in a graph.

As can be seen from (a) of FIG. 32, it can be found that the cathode active material according to experimental example 7-3 (730° C.) has a highest c/3a ratio. Accordingly, it can be found that the cathode active material according to experimental example 7-3 (730° C.) has the most excellent crystal stability. Thus, in the method for manufacturing the cathode active material according to the present invention, it can be found that the method for firing a transition metal hydroxide, a lithium salt, and a Mo dopant material at more than 725° C. and less than 750° C. is a method for improving the crystal stability of the cathode active material.

Referring to (b) of FIG. 32, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 5-1 (725° C.) to 5-5 (825° C.) to show a c/3a ratio in a graph.

As can be seen from (b) of FIG. 32, it can be found that the cathode active material according to experimental example 5-3 (775° C.) has a highest c/3a ratio. Accordingly, it can be found that the cathode active material according to experimental example 5-3 (775° C.) has the most excellent crystal stability. Thus, in the method for manufacturing the cathode active material according to the present invention, it can be found that the method for firing a transition metal hydroxide, a lithium salt, and a Ta dopant material at more than 750° C. and less than 800° C. is a method for improving the crystal stability of the cathode active material.

Referring to (c) of FIG. 32, an XRD analysis was performed on the cathode active materials according to comparative examples 1-1 (725° C.) to 1-4 (800° C.) to show a c/3a ratio in a graph. In addition, an XRD analysis was performed on the cathode active materials according to experimental examples 6-1 (725° C.) to 6-6 (900° C.) to show a c/3a ratio in a graph.

As can be seen from (c) of FIG. 32, it can be found that the cathode active material according to experimental example 6-5 (825° C.) has a highest c/3a ratio. Accordingly, it can be found that the cathode active material according to experimental example 6-5 (823° C.) has the most excellent crystal stability. Thus, in the method for manufacturing the cathode active material according to the present invention, it can be found that the method for firing a transition metal hydroxide, a lithium salt, and a W dopant material at more than 800° C. and less than 900° C. is a method for improving the crystal stability of the cathode active material.

TABLE 12

| | Target firing | c/3a | Dopant |
|---|---|---|---|
| Classification | temperature (° C.) | ratio | material |
| Comparative example 1-1 | 725 | 1.6458 | — |
| Comparative example 1-2 | 750 | 1.6455 | — |
| Comparative example 1-3 | 775 | 1.6451 | — |
| Comparative example 1-4 | 800 | 1.6452 | — |
| Experimental example 1-1 | 725 | 1.6449 | Nb |
| Experimental example 1-2 | 750 | 1.6469 | Nb |
| Experimental example 1-3 | 775 | 1.6453 | Nb |
| Experimental example 1-4 | 800 | 1.6454 | Nb |
| Experimental example 2-1 | 725 | 1.6453 | Ti |
| Experimental example 2-2 | 730 | 1.6470 | Ti |
| Experimental example 2-3 | 750 | 1.6459 | Ti |
| Experimental example 2-4 | 775 | 1.6452 | Ti |
| Experimental example 2-5 | 800 | 1.6464 | Ti |
| Experimental example 3-1 | 700 | 1.6447 | Zr |
| Experimental example 3-2 | 725 | 1.6465 | Zr |
| Experimental example 3-3 | 750 | 1.6449 | Zr |
| Experimental example 3-4 | 775 | 1.6447 | Zr |
| Experimental example 3-5 | 800 | 1.6447 | Zr |
| Experimental example 4-1 | 725 | 1.6457 | Hf |
| Experimental example 4-2 | 750 | 1.6469 | Hf |
| Experimental example 4-3 | 775 | 1.6461 | Hf |
| Experimental example 4-4 | 800 | 1.6458 | Hf |
| Experimental example 5-1 | 725 | 1.6459 | Ta |
| Experimental example 5-2 | 750 | 1.6454 | Ta |
| Experimental example 5-3 | 775 | 1.6461 | Ta |
| Experimental example 5-4 | 800 | 1.6453 | Ta |
| Experimental example 5-5 | 825 | 1.6457 | Ta |
| Experimental example 6-1 | 725 | 1.6447 | W |
| Experimental example 6-2 | 750 | 1.6456 | W |
| Experimental example 6-3 | 775 | 1.6447 | W |
| Experimental example 6-4 | 800 | 1.6447 | W |
| Experimental example 6-5 | 825 | 1.6462 | W |
| Experimental example 6-6 | 900 | 1.6439 | W |
| Experimental example 7-1 | 700 | 1.6443 | Mo |
| Experimental example 7-2 | 725 | 1.6449 | Mo |
| Experimental example 7-3 | 730 | 1.6459 | Mo |
| Experimental example 7-4 | 750 | 1.6454 | Mo |
| Experimental example 7-5 | 775 | 1.6456 | Mo |
| Experimental example 7-6 | 800 | 1.6458 | Mo |

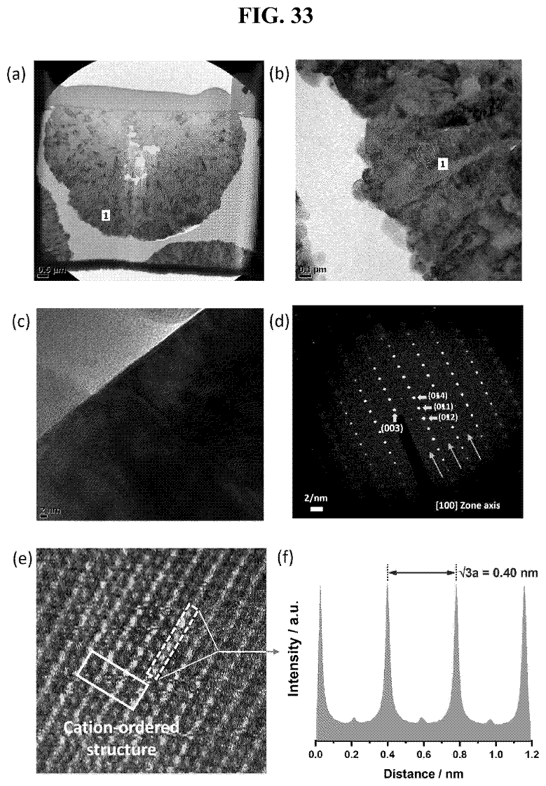

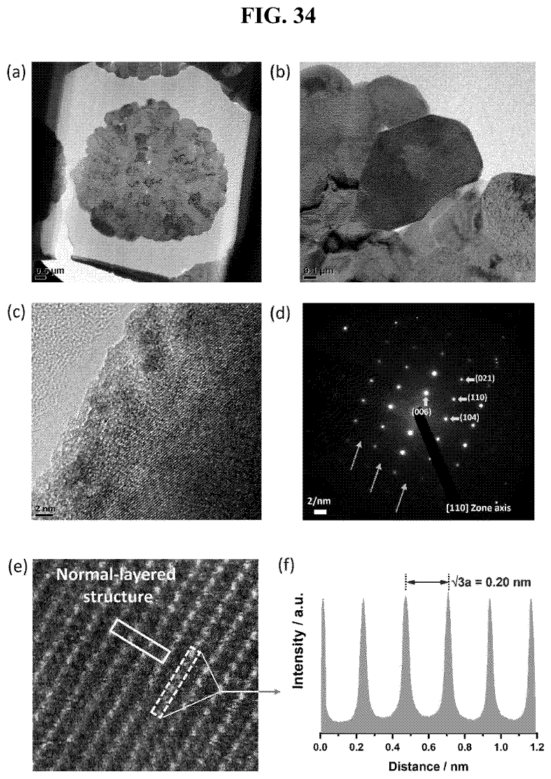

FIG. 33 is a FIB-TEM picture of a cathode active material according to experimental example 2-2 of the present invention, and FIG. 34 is an FIB-TEM picture of a cathode active material according to experimental example 2-5 of the present invention.

Referring to (a) to (d) of FIG. 33, the cathode active material according to experimental example 2-2 (Ti 730° C.) was photographed using FIB-TEM, and a length of a unit cell of the cathode active material was measured in a direction of dense filling. Referring to (a) to (d) of FIG. 34, the cathode active material according to experimental example 2-5 (Ti 800° C.) was photographed using FIB-TEM, and a length of a unit cell of the cathode active material was measured in a direction of dense filling.

As can be seen from (a) to (d) of FIG. 33, it can be found that the cathode active material according to experimental example 2-2 has a crystal structure in which a lithium layer and a transition metal layer of the cathode active material are alternately and repeatedly stacked. In addition, it can be found that the cathode active material according to experimental example 2-2 has 2 valent ions of a nickel metal of the transition metal layer mixed in the lithium layer. Accordingly, it can be found that a length of a unit cell of the cathode active material according to experimental example 2-2 is 0.40 nm in a direction of dense filling. Thus, it can be found that a lattice structure of the cathode active material according to experimental example 2-2 is a superlattice.

As can be seen from (a) to (d) of FIG. 34, it can be found that the cathode active material according to experimental example 2-5 has a crystal structure in which a lithium layer and a transition metal layer of the cathode active material are alternately and repeatedly stacked. In addition, it can be found that a length of a unit cell of the cathode active material according to experimental example 2-5 is 0.20 nm in a direction of dense filling. Thus, it can be found that a lattice structure of the cathode active material according to experimental example 2-5 is not a superlattice.

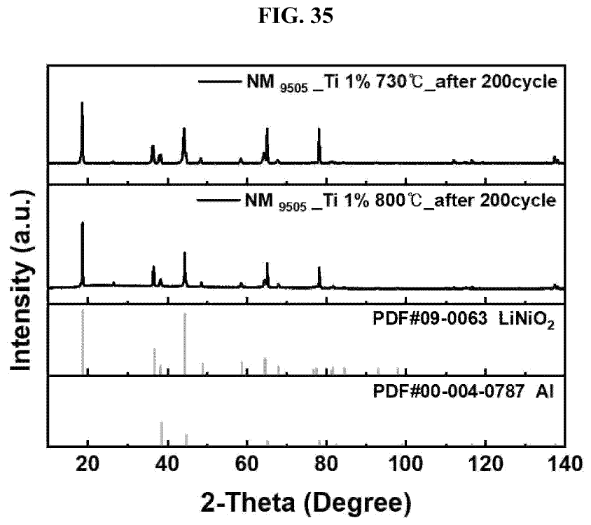

FIGS. 35 to 38 are graphs for comparing crystal structures of cathode active materials according to experimental examples 2-2 and 2-5 before/after charge/discharge cycles of a lithium ion battery with cathode active materials applied thereto according to experimental examples 2-2 and 2-5 of the present invention.

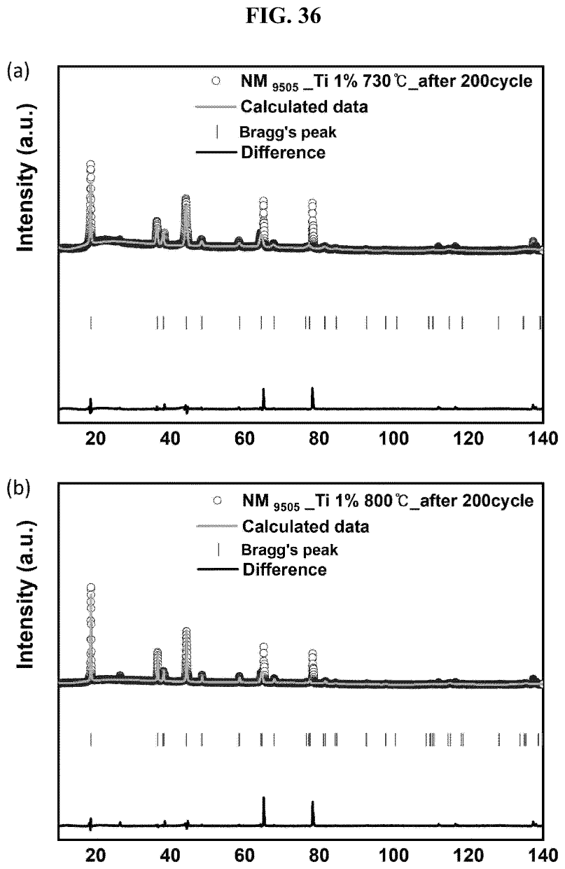

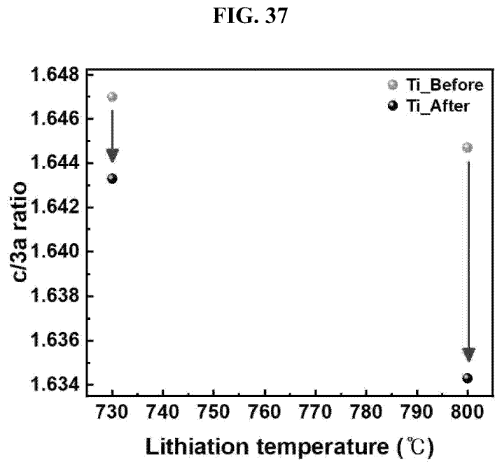

Referring to FIG. 35, the lithium ion battery with the cathode active materials applied thereto according to experimental examples 2-2 (Ti 730° C.) and 2-5 (Ti 800° C.) was subjected to 200 charge/discharge cycles, and then an XRD analysis was performed on the cathode active materials according to experimental examples 2-2 (Ti 730° C.) and 2-5 (Ti 800° C.). Referring to (a) of FIG. 36, the lithium ion battery with the cathode active material applied thereto according to experimental example 2-2 (Ti 730° C.) was subjected to 200 charge/discharge cycles, and then an XRD Rietveld refinement analysis was performed on the cathode active material according to experimental example 2-2 (Ti 730° C.). Referring to (b) of FIG. 36, the lithium ion battery with the cathode active material applied thereto according to experimental example 2-5 (Ti 800° C.) was subjected to 200 charge/discharge cycles, and then an XRD Rietveld refinement analysis was performed on the cathode active material according to experimental examples 2-5 (Ti 800° C.). Referring to FIG. 37, a c/3a ratio (black) is shown in a graph as a result of an XRD Rietveld refinement of the cathode active materials according to experimental examples 2-2 (Ti 730° C.) and 2-5 (Ti 800° C.) measured in (a) and (b) of FIG. 36. In addition, a c/3a ratio (orange) of the cathode active materials according to experimental examples 2-2 (Ti 730° C.) and 2-5 (Ti 800° C.) measured in (b) of FIG. 31 is shown in a graph. Furthermore, the data related to FIGS. 35 to 36 are summarized in <Table 13> below.

As can be seen from FIGS. 35 to 37, it can be found in the cathode active material according to experimental example 2-2 that a unit cell volume of the cathode active material is substantially maintained after 200 charge/discharge cycles, and thus a grain size of the cathode active material is maintained. On the contrary, it can be found that the cathode active material according to experimental example 2-5 has the unit cell volume changed after 200 charge/discharge cycles and thus the grain size is changed, compared to the cathode active material according to experimental example 2-2. In addition, it can be found that the cathode active material according to experimental example 2-5 has a c/3a ratio reduced by about three times after 200 charge/discharge cycles, compared to the cathode active material according to experimental example 2-2. Thus, it can be found that the cathode active material according to experimental example 2-2 has more excellent crystal stability for 200 charge/discharge cycles than that of the cathode active material according to experimental example 2-5.

TABLE 13

| | | | | | Unit | | Grain | |
|---|---|---|---|---|---|---|---|---|
| | | | | c/3a | cell | | size | |
| Classification | | a (Å) | c (Å) | ratio | volume | I₍₀₀₃₎/I₍₁₀₄₎ | (nm) | R_{WP} |
| Before | Experimental | 2.877 | 14.215 | 1.6470 | 101.896 | 1.043 | 42.8 | 4.014 |
| 200 | example 2-2 | | | | | | | |
| cycles | Experimental | 2.879 | 14.220 | 1.6464 | 102.074 | 1.150 | 118.6 | 3.967 |
| | example 2-5 | | | | | | | |
| After | Experimental | 2.885 | 14.220 | 1.6433 | 102.521 | 1.391 | 50.9 | 9.923 |
| 200 | example 2-2 | | | | | | | |
| cycles | Experimental | 2.889 | 14.165 | 1.6343 | 102.386 | 1.611 | 66.6 | 10.499 |
| | example 2-5 | | | | | | | |

Referring to (a) of FIG. 38, the W-H Plot for the cathode active material according to experimental example 2-2 (Ti 730° C.) was shown before the lithium ion battery with the cathode active material applied thereto according to experimental example 2-2 (Ti 730° C.) was subjected to 200 charge/discharge cycles. Referring to (b) of FIG. 38, the W-H Plot for the cathode active material according to experimental example 2-2 (Ti 730° C.) was shown after the lithium ion battery with the cathode active material applied thereto according to experimental example 2-2 (Ti 730° C.) was subjected to 200 charge/discharge cycles. Referring to (c) of FIG. 38, the W-H Plot for the cathode active material according to experimental example 2-5 (Ti 800° C.) was shown before the lithium ion battery with the cathode active material applied thereto according to experimental example 2-5 (Ti 800° C.) was subjected to 200 charge/discharge cycles. Referring to (d) of FIG. 38, the W-H Plot for the cathode active material according to experimental example 2-5 (Ti 800° C.) was shown after the lithium ion battery with the cathode active material applied thereto according to experimental example 2-5 (Ti 800° C.) was subjected to 200 charge/discharge cycles. Referring to (e) of FIG. 38, the slope (red) for the W-H Plot of the cathode active material according to experimental examples 2-2 (Ti 730° C.) and 2-5 (Ti 800° C.) was shown before the lithium ion battery with the cathode active materials applied thereto according to experimental examples 2-2 (Ti 730° C.) and 2-5 (Ti 800° C.) was subjected to 200 charge/discharge cycles. In addition, the slope (blue) for the W-H Plot of the cathode active material according to experimental examples 2-2 (Ti 730° C.) and 2-5 (Ti 800° C.) was shown after the lithium ion battery with the cathode active materials applied thereto according to experimental examples 2-2 (Ti 730° C.) and 2-5 (Ti 800° C.) was subjected to 200 charge/discharge cycles.

As can be seen from (a) to (e) of FIG. 38, it can be found that the slope for the W-H Plot is reduced after the cathode active material according to experimental examples 2-2 was subjected to 200 charge/discharge cycles. On the contrary, it can be found that the slope for the W-H Plot is increased after the cathode active material according to experimental examples 2-5 was subjected to 200 charge/discharge cycles. This factor may be interpreted as being due to the fact that a weaker stress was applied to a plane (104) of the cathode active material than before being subjected to 200 charge/discharge cycles while the cathode active material according to experimental example 2-2 was subjected to 200 charge/discharge cycles. In addition, this may be interpreted as being due to the fact that the primary particles of the cathode active material according to experimental example 2-5 were destroyed during 200 charge/discharges and thus a strong stress was applied to a plane (104) before being subjected to 200 charge/discharge cycles.

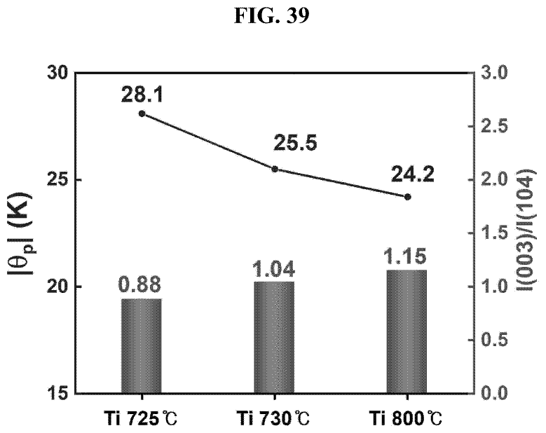

FIG. 39 is an SEM picture of cathode active materials according to experimental examples 2-2 and 2-5 after performing charge/discharge cycles of a lithium ion battery with cathode active materials applied thereto according to experimental examples 2-2 and 2-5 of the present invention.

Referring to (a) of FIG. 39, the cathode active material according to experimental example 2-2 was photographed using SEM after the lithium ion battery with the cathode active material applied thereto according to experimental example 2-2 was subjected to 200 charge/discharge cycles. Referring to (b) of FIG. 39, the cathode active material according to experimental example 2-2 was photographed using SEM after the lithium ion battery with the cathode active material applied thereto according to experimental example 2-5 was subjected to 200 charge/discharge cycles.

As can be seen from (a) and (b) of FIG. 39, it can be found that the shape of the cathode active material is maintained after the cathode active material according to experimental examples 2-2 was subjected to 200 charge/discharge cycles. On the contrary, it can be found that the primary particles of the cathode active material according to experimental example 2-5 are destroyed and thus have an irregular shape after being subjected to 200 charge/discharge cycles. Thus, it can be found that the cathode active material according to experimental example 2-2 has more excellent durability for charge/discharge cycles than the cathode active material according to experimental example 2-5.

FIG. 40 is a graph for comparing a temperature constant (θp) and I₍₀₀₃₎/I₍₁₀₄₎ for cathode active materials according to experimental examples 2-1, 2-2 and 2-5 of the present invention.

Referring to FIG. 40, a magnetic moment of the cathode active materials according to experimental examples 2-1 (Ti 725° C.), 2-2 (Ti 730° C.), and 2-5 (Ti 800° C.) was measured for each temperature. In addition, a slope was calculated by a Linear Fitting method using a magnetic moment graph according to a measured temperature of the cathode active materials according to experimental examples 2-1 (Ti 725° C.), 2-2 (Ti 730° C.), and 2-5 (Ti 800° C.) and <Equation 1> below, and a Curie constant (Cₚ) for the cathode active materials according to experimental examples 2-1 (Ti 725° C.), 2-2 (Ti 730° C.), and 2-5 (Ti 800° C.) was calculated in <Equation 1> below. In addition, an Y-intercept value of the magnetic moment graph according to the temperature of the cathode active materials according to experimental examples 2-1 (Ti 725° C.), 2-2 (Ti 730° C.), and 2-5 (Ti 800° C.) after Linear Fitting was multiplied by the Curie constant (Cₚ) for the cathode active materials according to experimental examples 2-1 (Ti 725° C.), 2-2 (Ti 730° C.), and 2-5 (Ti 800° C.), so as to obtain the temperature constant (θp) for the cathode active materials according to experimental examples 2-1 (Ti 725° C.), 2-2 (Ti 730° C.), and 2-5 (Ti 800° C.), which was shown in a graph. Furthermore, I₍₀₀₃₎/I₍₁₀₄₎ of the cathode electrode active materials according to experimental examples 2-1 (Ti 725° C.), 2-2 (Ti 730° C.), and 2-5 (Ti 800° C.) measured in (b) of FIG. 14 is shown together in a graph.

χ⁻¹=(T−θₚ)/Cₚ (χ=Magnetic susceptibility, T=Temperature (K), θₚ=Temperature constant, Cₚ=Curie constant) <Equation 1>

As can be seen from FIG. 40, it can be found that the cathode active material according to experimental example 2-1 has a temperature constant of 28.1K and I₍₀₀₃₎/I₍₁₀₄₎ of 0.88. It can be found that the cathode active material according to experimental example 2-2 has a temperature constant of 25.5K and I₍₀₀₃₎/I₍₁₀₄₎ of 1.04. It can be found that the cathode active material according to experimental example 2-5 has a temperature constant of 24.2K and I₍₀₀₃₎/I₍₁₀₄₎ of 1.15.

As the temperature constant of the cathode active material increases, a ratio at which +2 valent ions of the nickel metal are mixed in the lithium layer of the cathode active material may increase, and as the I₍₀₀₃₎/I₍₁₀₄₎ of the cathode active material decreases, a ratio at which +2 valent ions of the nickel metal are mixed in the lithium layer of the cathode active material may decrease.

Accordingly, it can be found that the ratio at which +2 valent ions of the nickel metal are mixed in the lithium layer of the cathode active material becomes higher in the order of the cathode active material according to experimental example 2-1, the cathode electrode active material according to experimental example 2-2, and the cathode active material according to experimental example 2-5.

In addition, as described in (a) and (b) of FIG. 9, it can be found that the initial capacity of the lithium ion battery with the cathode active material applied thereto and the capacity retention rate thereof according to experimental example 2-2 is optimized. Accordingly, it can be found that the ratio at which +2 valent ions of the nickel metal are mixed in the lithium layer of the cathode active material according to experimental example 2-2 is optimized.

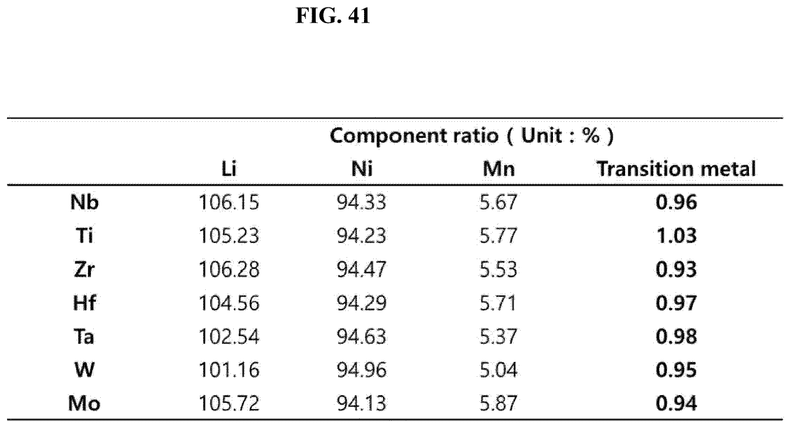

FIG. 41 is a table for comparing results of ICP analysis on cathode active materials according to experimental examples of the present invention.

Referring to FIG. 41, the cathode active materials according to experimental examples 1-2 (Nb), 2-2 (Ti), 3-2 (Zr), 4-2 (Hf), 5-3 (Ta), 6-5 (W), and 7-3 (Mo) were analyzed by ICP.

As can be seen from FIG. 41, it can be found that the cathode active material according to experimental examples includes a lithium metal, a nickel metal at a lower ratio than that of the lithium metal, a manganese metal at a lower ratio than that of the nickel metal, and a dopant at a lower ratio than that of the manganese metal.

Although the present invention has been described in detail using preferred embodiments, the scope of the present invention is not limited to specific embodiments and should be interpreted by the appended claims. In addition, it should be understood by those skilled in the art that many modifications and variations are possible without departing from the scope of the present invention.

### INDUSTRIAL APPLICABILITY

A cathode active material according to an embodiment of the present invention may be used in various devices such as a lithium ion battery, an electric vehicle, a mobile device, an ESS, etc.

What is claimed is:

1. A method for manufacturing a cathode active material, the method comprising:
preparing a cathode active material precursor;
setting a temperature in heat treatment equipment to a target firing temperature; and
firing the cathode active material precursor, a lithium salt, and a dopant material at the target firing temperature using the heat treatment equipment to manufacture a cathode active material,
wherein the target firing temperature is controlled according to the dopant material, and an initial capacity and a capacity retention rate of a lithium secondary battery is controlled according to the target firing temperature.

2. The method of claim 1, wherein
the dopant material is Ti and the target firing temperature is more than 725° C. and less than 750° C.,
the dopant material is Hf and the target firing temperature is controlled to be more than 725° C. and less than 775° C.,
the dopant material is Nb and the target firing temperature is controlled to be more than 725° C. and less than 775° C.,
the dopant material is Ta and the target firing temperature is controlled to be more than 750° C. and less than 800° C.,
the dopant material is W and the target firing temperature is controlled to be more than 800° C. and less than 900° C.,
the dopant material is Mo and the target firing temperature is controlled to be more than 725° C. and less than 750° C., or
the dopant material is Zr and the target firing temperature is controlled to be more than 700° C. and less than 750° C.

3. The method of claim 1, wherein the preparing of the cathode active material precursor includes manufacturing a transition metal hydroxide by a co-precipitation method using a transition metal precursor.

4. The method of claim 3, wherein the transition metal precursor does not include cobalt, and the transition metal precursor includes a nickel precursor and a manganese precursor.

5. The method of claim 4, wherein a ratio of the cathode active material precursor, the lithium salt, and the dopant material is controlled to be 1.03:1.00:0.01.

6. The method of claim 5, wherein the nickel precursor includes NiSO₄6H₂O, the manganese precursor includes MnSO₄5H₂O, and the lithium salt includes LiOHH₂O.

7. A method for manufacturing a cathode active material, the method comprising:
heat-treating a preliminary cathode active material manufactured by mixing a cathode active material precursor, a lithium salt, and zirconium as a dopant material at a target firing temperature,
wherein, in a process of heat-treating at the target firing temperature, stress is applied to a first plane of the preliminary cathode active material, and particles of the cathode active material grow to a second plane rather than the first plane.

8. The method of claim 7, wherein I₍₀₀₃₎/I₍₁₀₄₎, which is a ratio of a peak value I₍₀₀₃₎ corresponding to the second plane and a peak value I₍₁₀₄₎ corresponding to the first plane, is controlled to be more than 1.0 and less than 1.1.

9. The method of claim 8, wherein the dopant material includes at least one of Nb, Ti, Zr, Hf, Ta, W, or Mo.

10. A cathode active material comprising a secondary particle in which a plurality of primary particles are aggregated, wherein
among a surface and an inside of the cathode active material, more primary particles having a rod shape are included on the surface than in the inside, in which
the cathode active material includes a lithium metal, a nickel metal at a smaller ratio than that of the lithium metal, a manganese metal at a smaller ratio than that of the nickel metal, and a dopant at a smaller ratio than that of the manganese metal, in which
the dopant ratio is higher on the surface than in the inside,
a grain size of the cathode active material is 40 nm or more and 60 nm or less, and
when the cathode active material is subjected to XRD analysis, I₍₀₀₃₎/I₍₁₀₄₎, which is a ratio between a peak value I₍₀₀₃₎ corresponding to a plane and a peak value I₍₁₀₄₎ corresponding to a plane, is more than 1.0 and less than 1.1.

11. The cathode active material of claim 10,
when the cathode active material is subjected to XRD analysis, c/3a, which is a ratio of a crystal lattice of the cathode active material to a c-axis and an a-axis, exceeds 1.6459.

12. The cathode active material of claim 10,
the cathode active material includes a transition metal layer including the nickel metal and the manganese metal and a lithium layer including the lithium metal, which are alternately and repeatedly stacked, and a superlattice in which +2 valent ions of the nickel metal are mixed in the lithium layer.

13. The cathode active material of claim 10, wherein the dopant includes Ti, a ratio at which +2 valent ions of the nickel metal are mixed in a lithium layer increases as a temperature constant (θp) of the cathode active material increases, and the temperature constant (θp) of the cathode active material is more than 24.2K and less than 28.1K.
